(19) United States
(12) Patent Application Publication
(10) Pub. No.: US 2025/0360764 A1
(43) Pub. Date: Nov. 27, 2025

(54) WHEEL MODULE

(71) Applicant: HL MANDO CORPORATION, Pyeongtaek (KR)

(72) Inventor: Junho SEONG, Seoul (KR)

(21) Appl. No.: 19/288,990

(22) Filed: Aug. 2, 2025

Related U.S. Application Data
(62) Division of application No. 18/159,120, filed on Jan. 25, 2023.

(30) Foreign Application Priority Data
Jan. 25, 2022 (KR) 10-2022-0010785
Jan. 25, 2022 (KR) 10-2022-0010835
Jan. 25, 2022 (KR) 10-2022-0010836
Jan. 25, 2022 (KR) 10-2022-0010837

(51) Int. Cl. B60G 3/20; B60G 15/06; B62D 7/18

(52) U.S. Cl. CPC B60G 3/20; B60G 15/068; B60G 2200/144; B60G 2200/44; B62D 7/18

(57) ABSTRACT

A wheel module is disclosed. The wheel module according to the present embodiment includes a knuckle configured to rotatably support a wheel, a steering device including an actuator configured to rotate the knuckle and steer the wheel, and a reinforcing structure provided between the knuckle and a vehicle body, wherein an output shaft of the actuator is disposed parallel to a vertical direction, the reinforcing structure includes a first end rotatably connected to the knuckle along a first axis parallel to the vertical direction and a second end connected to the vehicle body, and a rotation axis of the output shaft and the first axis are coaxially provided.

### CROSS-REFERENCE TO RELATED APPLICATION(S)

This is a Divisional Application of U.S. application Ser. No. 18/159,120 filed on Jan. 25, 2023 which claims priority under 35 U.S.C. § 119 to Korean Patent Application Nos. 10-2022-0010785, filed on Jan. 25, 2022, 10-2022-0010835, filed on Jan. 25, 2022, 10-2022-0010836, filed on Jan. 25, 2022, and 10-2022-0010837, filed on Jan. 25, 2022, in the Korean Intellectual Property Office, the disclosure of which is incorporated herein by reference.

### BACKGROUND

### 1. Field

Embodiments of the present disclosure relate to a wheel module, and more particularly, to a wheel module that can be stably installed and operated in a vehicle body of a vehicle while separately driving and steering a plurality of wheels disposed in the vehicle and stably absorbing impact transmitted from a road surface.

### 2. Description of the Related Art

Generally, in a vehicle, a power source such as an engine is installed in a separate space of a vehicle body, and power is transmitted to wheels of the vehicle via various power transmission members such as a gearbox and a drive shaft to rotate the wheels and implement driving of the vehicle.

However, in recent years, there have been attempts to separately drive wheels by mounting a driving device on an inner side of each wheel without installing a power source such as an engine in a separate space of a vehicle body. In particular, with a surge in the market demand for electric vehicles that use electricity as a power source, an in-wheel system in which a driving device operated by electrical energy is mounted on an inner side of each wheel of a vehicle has been developed. The in-wheel system has advantages that, since the driving device directly drives the wheel without using a power transmission member, power loss is low, and since it is possible to omit various components including an engine, the weight of the vehicle can be reduced, and fuel efficiency can be improved.

Meanwhile, nowadays, with an increase in the market interest and demand for driving assistance or autonomous driving of vehicles, a brake system in which a hydraulic connection between a brake pedal and a vehicle's braking device is disconnected and a driver's intention to brake is received by an electrical signal to perform braking of wheels has been developed, and a steering system in which a mechanical connection between a steering wheel such as a handle and a vehicle's steering device is disconnected and a driver's intention to steer is received by an electrical signal to perform steering of wheels has also been developed.

Further, due to a day-by-day increase in the demand for private cars and an increase in the vehicle density in urban areas, a solution for maneuverability or parking of vehicles in a narrow space is required. In synchronization with the market and development environment, development of a wheel module in which, in the in-wheel system provided for each wheel, the brake system and the steering system are embedded together to significantly expand a steering angle of the wheels and a suspension system for absorbing impact transmitted from a road surface is also embedded to separately operate and control each wheel is in progress.

However, since devices for driving, braking, steering, and suspending the wheels are collectively embedded in the wheel module, there is concern that the durability and operational reliability of various components may be reduced due to loads in various directions that are applied to the wheels during traveling of the vehicle. Also, there is a problem that, in a case in which a thickness of a structure is increased to secure the stiffness of the wheel module, the space utilization of the vehicle is degraded, and thus the advantages of the wheel module are offset.

### SUMMARY

Therefore, it is an aspect of the present embodiments to provide a wheel module which can improve durability and operational stability of components despite loads in various directions that are transferred to each wheel during traveling of a vehicle.

It is another aspect of the present embodiments to provide a wheel module which can secure a wide indoor space of a vehicle and improve the space utilization of the vehicle by reducing the size or scale of a device.

It is another aspect of the present embodiments to provide a wheel module which can improve maneuverability of a vehicle by implementing a large steering angle even in a small installation space.

It is another aspect of the present embodiments to provide a wheel module which has a simple structure and is easy to manufacture and install.

It is another aspect of the present embodiments to provide a wheel module which can improve operational reliability by improving structural stability.

It is another aspect of the present embodiments to provide a wheel module which can stably and separately drive, brake, steer, and suspend each wheel.

Additional aspects of the disclosure will be set forth in part in the description which follows and, in part, will be obvious from the description, or may be learned by practice of the disclosure.

In accordance with one aspect of the present disclosure, a wheel module includes a knuckle configured to rotatably support a wheel, a steering device including an actuator configured to rotate the knuckle and steer the wheel, and a reinforcing structure provided between the knuckle and a vehicle body, wherein an output shaft of the actuator is disposed parallel to a vertical direction, the reinforcing structure includes a first end rotatably connected to the knuckle along a first axis parallel to the vertical direction and a second end connected to the vehicle body, and a rotation axis of the output shaft and the first axis are coaxially provided.

The second end may be rotatably connected to the vehicle body along a second axis parallel to a longitudinal direction of the vehicle body.

The reinforcing structure may further include a third end connected to the vehicle body, and the third end may be rotatably connected to the vehicle body along a third axis parallel to the vertical direction.

The third end may be disposed relatively behind the second end on the vehicle body.

The reinforcing structure may be provided to further include a first frame having one end at which the first end is disposed and the other end at which the second end is disposed and a second frame having one end at which the first end is disposed and the other end at which the third end is disposed.

The first frame may be formed to extend in a width direction of the vehicle body, and the second frame may be formed to extend toward a rear of the vehicle body and formed to be inclined with respect to the first frame.

The reinforcing structure may be provided to further include a support frame having one end connected to the first frame and the other end connected to the second frame.

The wheel module may be provided to further include a suspension device provided between the steering device and the knuckle.

The steering device may be provided to further include a fork connected to the output shaft and configured to rotate.

The fork may be provided to include a first fork formed to extend in a horizontal direction above the wheel and connected to the output shaft of the actuator and a second fork formed to extend downward from an inner side end of the first fork.

The wheel module may be provided to further include a driving device installed on an inner side of the wheel and configured to provide a rotational force of the wheel and a braking device configured to control a rotational speed of the wheel.

The knuckle may be provided to include a hub connected to at least any one of the driving device and the braking device and a bracket formed to extend or expand from an inner side end of the hub.

The suspension device may be provided to include an upper arm having one end rotatably connected to an upper side of the bracket and the other end rotatably connected to an upper side of the second fork and a lower arm having one end rotatably connected to a lower side of the bracket and the other end rotatably connected to a lower side of the second fork.

The suspension device may be provided to further include a damper having one end supported by the first fork and the other end supported by the lower arm.

The damper may be provided to include a main body of which a lower end is rotatably connected to and supported by the lower arm, a piston rod of which at least one portion is provided to be insertable into the main body and an upper end is rotatably connected to and supported by the first fork, and a spring disposed on an outer side of the piston rod and configured to elastically support the main body and the piston rod relative to each other.

The first end may be connected to a lower end of the hub.

The second end and the third end may be connected at the same height on the vehicle body.

The second axis and the third axis may be disposed on the same phase based on the longitudinal direction of the vehicle body.

The support frame may be formed to extend in a direction parallel to the longitudinal direction of the vehicle body.

The damper may be provided to further include a first support installed to be fixed to the main body and configured to support one end of the spring and a second support installed to be fixed to the first fork or the piston rod and configured to support the other end of the spring.

In accordance with another aspect of the present disclosure, a wheel module includes a knuckle configured to rotatably support a wheel, a steering device configured to rotate the knuckle and steer the wheel, and a reinforcing structure provided between the knuckle and a vehicle body, wherein the reinforcing structure includes a first end rotatably connected to the knuckle and a second end and a third end each rotatably connected to the vehicle body, and a rotation axis of the second end and a rotation axis of the third end are provided to be orthogonal to each other.

In accordance with still another aspect of the present disclosure, a wheel module includes a knuckle configured to rotatably support a wheel, a steering device configured to rotate the knuckle and steer the wheel, and a reinforcing structure provided between the knuckle and a vehicle body, wherein the reinforcing structure includes a first end rotatably connected to the knuckle along a first axis, a second end rotatably connected to the vehicle body along a second axis, and a third end rotatably connected to the vehicle body along a third axis, any one of the second axis and the third axis is disposed in a direction parallel to the first axis, and the second axis and the third axis are provided to be orthogonal to each other.

In accordance with yet another aspect of the present disclosure, a vehicle including a wheel module configured to separately drive and control each wheel is provided, the wheel module being in accordance with any one of the above aspects of the present disclosure.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view illustrating a wheel module according to a first embodiment of the present disclosure;

FIG. 2 is a lateral view illustrating the wheel module according to the first embodiment of the present disclosure;

FIG. 3 is a lateral cross-sectional view illustrating the wheel module according to the first embodiment of the present disclosure;

FIG. 4 is a plan view illustrating the wheel module according to the first embodiment of the present disclosure;

FIG. 5 is a view illustrating an operational state of the wheel module according to the first embodiment of the present disclosure;

FIG. 6 is a perspective view illustrating a wheel module according to a second embodiment of the present disclosure;

FIG. 7 is a lateral view illustrating the wheel module according to the second embodiment of the present disclosure;

FIG. 8 is a lateral cross-sectional view illustrating the wheel module according to the second embodiment of the present disclosure;

FIG. 9 is a view illustrating an operational state of the wheel module according to the second embodiment of the present disclosure;

FIG. 10 is a perspective view illustrating a wheel module according to a third embodiment of the present disclosure;

FIG. 11 is a lateral view illustrating the wheel module according to the third embodiment of the present disclosure;

FIG. 12 is a cross-sectional view taken along line A-A′ of FIG. 11;

FIG. 13 is a view illustrating an operational state of the wheel module according to the third embodiment of the present disclosure;

FIG. 14 is a perspective view illustrating a wheel module according to a fourth embodiment of the present disclosure;

FIG. 15 is an enlarged view of portion B of FIG. 14 and illustrates a fork body, a fork link, and a support groove according to the fourth embodiment of the present disclosure;

FIG. 16 is a lateral view illustrating the wheel module according to the fourth embodiment of the present disclosure;

FIG. 17 is an enlarged view of portion C of FIG. 16;

FIG. 18 is a view illustrating an operational state of the wheel module according to the fourth embodiment of the present disclosure; and

FIG. 19 is a lateral view illustrating a modified embodiment of the wheel module according to the fourth embodiment of the present disclosure.

### DETAILED DESCRIPTION

Hereinafter, embodiments of the present disclosure will be described in detail with reference to the accompanying drawings. The following embodiments are presented to sufficiently convey the spirit of the present disclosure to those of ordinary skill in the art to which the present disclosure pertains. The present disclosure is not limited to the embodiments presented herein and may be embodied in other forms. In the drawings, illustration of parts irrelevant to the description is omitted to clarify the present disclosure, and the size of elements may be somewhat exaggerated to help understanding.

In recent years, an in-wheel system in which, without a vehicle power source such as an engine being installed in a separate space of a vehicle body, a driving device is mounted on an inner side of each wheel to separately drive each wheel has been developed. In particular, with a surge in the market demand for electric vehicles that use electricity as a power source, the in-wheel system operated by electrical energy is expected to be spotlighted.

Also, with an increase in the market interest and demand for driving assistance or autonomous driving of vehicles, a brake system in which a driver's intention to brake is received by an electrical signal to perform braking of wheels has been developed, and a steering system in which a driver's intention to steer is received by an electrical signal to perform steering of wheels has also been developed.

Further, due to an increase in the vehicle density in urban areas, a solution for maneuverability and parking of vehicles in a narrow space is required. In synchronization with the market and development environment, it is required to develop a wheel module in which, in the in-wheel system provided for each wheel, the brake system and the steering system are embedded together to significantly expand a steering angle of the wheels and a suspension system for absorbing impact transmitted from a road surface is also embedded to separately operate and control each wheel.

Since devices for driving, braking, steering, and suspending the wheels are collectively embedded in the wheel module, there is concern that the durability and operational reliability of various components may be reduced due to loads in various directions that are applied to the wheels during traveling of the vehicle. Also, there is a problem that, in a case in which a thickness of a structure is increased to secure the stiffness of the wheel module, the space utilization of the vehicle is degraded.

Accordingly, wheel modules 100, 200, 300, and 400 according to the present embodiments are provided to, while promoting structural stability and operational reliability of a device despite loads in various directions that are applied to a wheel 10, reduce the size and scale of the device and improve space utilization of a vehicle.

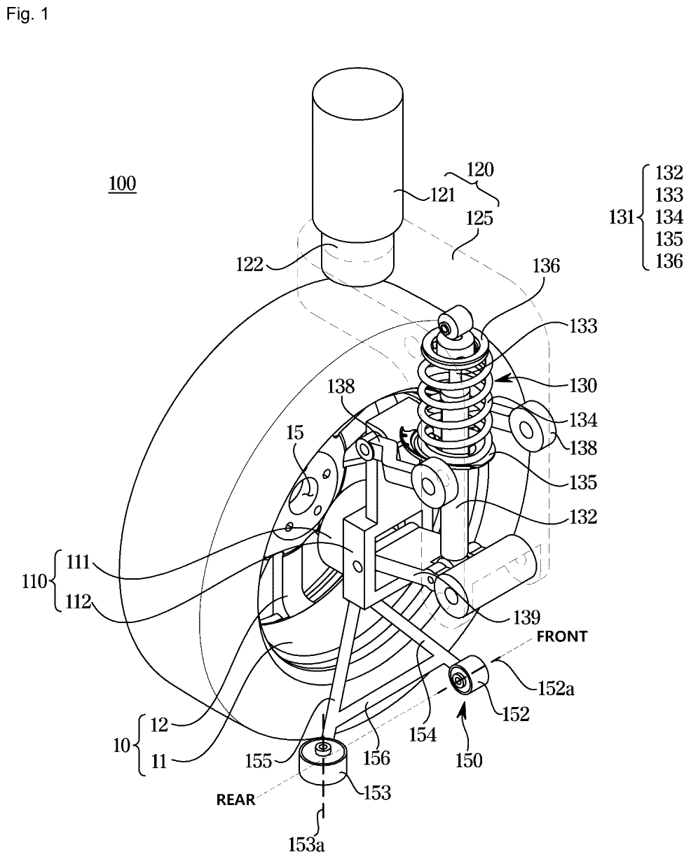

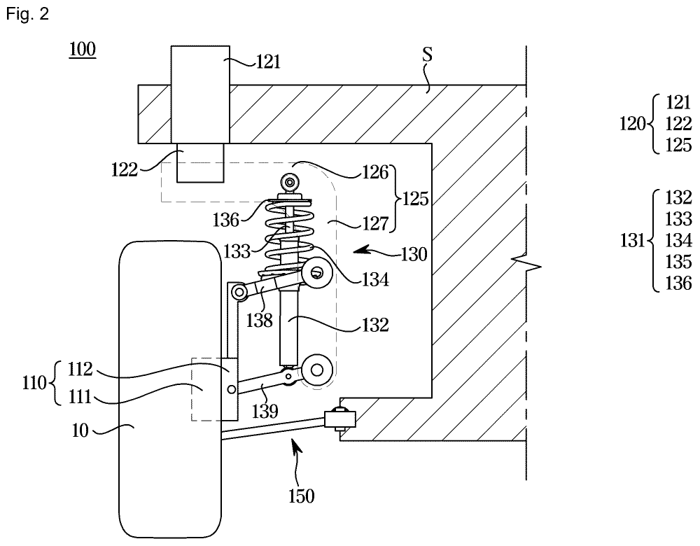

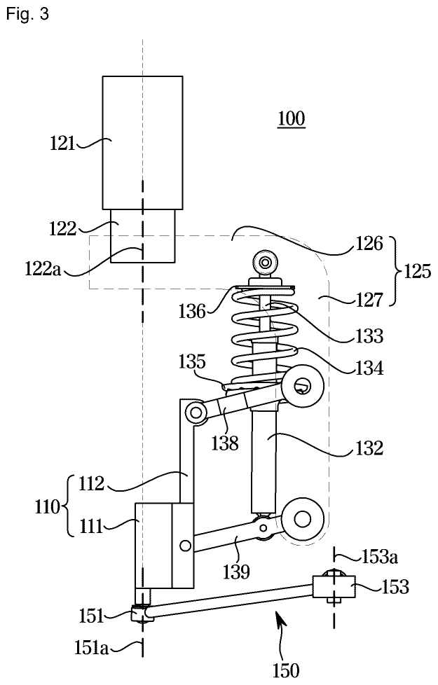

FIGS. 1 to 5 are views illustrating the wheel module 100 according to a first embodiment of the present disclosure. Specifically, FIGS. 1 and 2 are a perspective view and a lateral view illustrating the wheel module 100 according to the first embodiment of the present disclosure, and FIG. 3 is a lateral cross-sectional view illustrating the wheel module 100 according to the first embodiment of the present disclosure.

Referring to FIGS. 1 to 3, the wheel module 100 according to the first embodiment of the present disclosure is provided to include a driving device installed on an inner side of the wheel 10 of a vehicle and configured to provide a rotational force of the wheel 10, a braking device configured to control a rotational speed of the wheel 10 and brake the vehicle, a steering device 120 configured to steer the wheel 10, a suspension device 130 configured to absorb and reduce vibration, noise, and the like transmitted from a road surface to the wheel 10, a knuckle 110 configured to rotatably support the wheel 10, and a reinforcing structure 150 provided between the knuckle 110 and a vehicle body S to increase the stiffness of the wheel module 100.

The vehicle body S which will be described below is a part of a vehicle and may be understood as a concept encompassing various fixtures or fixed portions that can stably support components such as a chassis.

The wheel 10 may be provided as a plurality of wheels 10 installed on a vehicle, and the wheel module 100 according to the first embodiment of the present disclosure may be provided on each of the plurality of wheels 10. The wheel 10 may rotate while in contact with a road surface and thus cause the vehicle to move, and the wheel 10 may include a rim 11 having an outer peripheral portion along which a tire is installed and at least one spoke 12 connected to the rim 11 to rotate along with the rim 11 and form an exterior of the wheel 10. The driving device configured to provide a rotational force to the wheel 10 and cause the vehicle to travel and the braking device configured to control the rotational speed of the wheel 10 and brake the vehicle may be disposed on a mounting portion 15 at an inner side that is formed by the rim 11 and the spoke 12.

The driving device (not illustrated) may be provided on an inner side of the mounting portion 15 of the wheel 10 and may receive power from a power supply such as a battery and generate rotation power for rotation of the wheel 10. The driving device may include a driving motor (not illustrated) configured to generate the rotation power by electrical energy, and the driving motor may include a rotor installed to be fixed to the spoke 12, a rotator installed to be fixed to the rotor and having a magnetic force, and a stator provided to face the rotator and having a magnetic force. However, this is only an example to help understanding the present disclosure, and the present disclosure is not limited thereto. As long as the driving device is disposed on the inner side of the wheel 10 and may receive power and cause the wheel 10 to rotate and the vehicle to move, the driving device may be understood to be the same as above even in a case in which the driving device is provided as a device of various other methods and structures.

The braking device (not illustrated) may be provided on the inner side of the mounting portion 15 of the wheel 10 like the driving device and may suppress the rotation of the wheel 10 and perform braking of the vehicle. The braking device may be provided as a device of various methods that is configured to receive power from a power supply such as a battery and control the rotational speed of the wheel 10. As an example, the braking device may, by a structure made of a nut and a spindle and configured to convert a rotational force of a braking motor configured to generate power into linear motion, approach and move away from the rim 11 to control the rotational speed of the wheel 10. In addition, the braking device may use a piston, configured to move back and forth by the power of the braking motor, to generate a liquid pressure in a pressurizing medium and transmit the liquid pressure to a cylinder provided at the wheel 10 to control the rotational speed of the wheel 10. However, the present disclosure is not limited thereto, and of course, as long as the braking device is disposed on the inner side of the wheel 10 and may receive power and control the rotational speed of the wheel 10 to perform braking of the vehicle, the braking device according to the present embodiment may be provided as a device of various other methods and structures.

At least any one of the driving device and the braking device may be rotatably supported by and connected to the knuckle 110 and thus be supported by the vehicle body S, and the knuckle 110 may rotatably support the wheel 10 via the driving device or the braking device. Also, by being provided to connect the wheel 10 to the steering device 120 and the suspension device 130 which will be described below, the knuckle 110 may transmit an operation of the steering device 120 to the wheel 10 to perform steering of the wheel 10 or may transmit vibration and noise applied from a road surface to the wheel 10 to the suspension device 130 to induce attenuation of the vibration and noise.

The knuckle 110 may include a hub 111 connected to at least any one of the driving device and the braking device and a bracket 112 formed to extend from an inner side end (a right side end based on FIG. 2) of the hub 111 and connected to the steering device 120 and the suspension device 130 which will be described below.

An outer side end (a left side end based on FIG. 2) of the hub 111 may rotatably support the wheel 10 via the driving device or the braking device, and in order to promote weight reduction and simplify the structure, the hub 111 may be provided in the shape of a ring and may be disposed to be coaxial with a rotation axis of the wheel 10. A first end 151 of the reinforcing structure 150 which will be described below may be rotatably connected to a lower end of the hub 111, and this will be described in detail below.

The bracket 112 may be formed to extend in the vertical direction or up-down direction from the inner side end of the hub 111, one end of an upper arm 138 which will be described below may be rotatably connected to an upper side of the bracket 112, and one end of a lower arm 139 which will be described below may be rotatably connected to a lower side of the bracket 112. Rotation axes of the upper arm 138 and the lower arm 139 relative to the bracket 112 may be disposed parallel to the front-rear direction of the wheel 10, and thus the suspension device 130 can stably absorb and attenuate vibration and impact in the up-down direction that are applied to the wheel 10 from a speed bump on a road or from a damaged road surface. Also, as the one end of the upper arm 138 and the one end of the lower arm 139, which will be described below, are each connected to the bracket 112, the upper arm 138 and the lower arm 139 may be rotated or displaced along with the knuckle 110, and in this way, the suspension device 130 can stably intervene and operate regardless of a steering angle of the wheel 10.

An inlet formed to be penetrated in a direction parallel to a direction of a central axis of the hub 111 may be provided in the lower side of the bracket 112 to prevent interference between components during rotation of the bracket 112 and the lower arm 139 relative to each other while the one end of the lower arm 139 which will be described below is installed by being inserted into the inlet to minimize an installation space of the device.

The steering device 120 is provided to rotate the knuckle 110 and the wheel 10 connected thereto to steer the wheel 10.

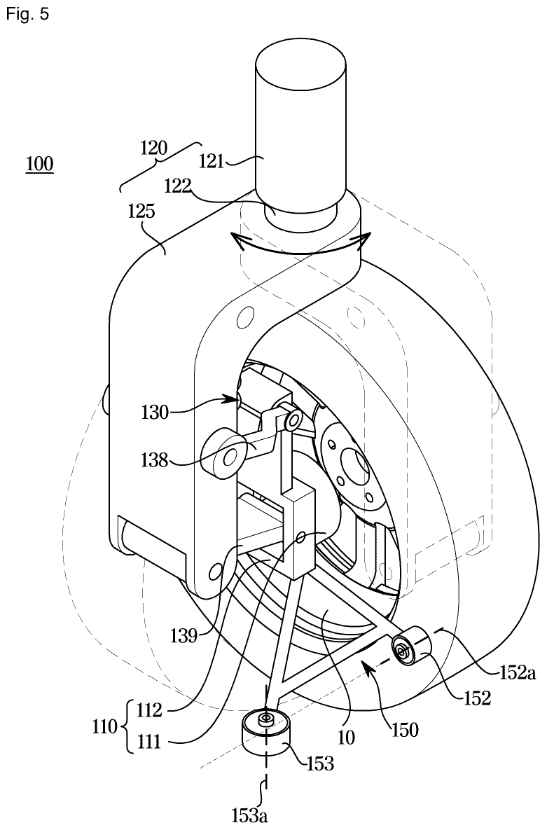

FIG. 5 is a perspective view illustrating an operational state in which the wheel 10 is steered by the steering device 120. Referring to FIGS. 1 to 3 and FIG. 5, the steering device 120 may include an actuator 121 configured to provide rotation power for steering of the wheel 10 and a fork 125 connected to an output shaft 122 of the actuator 121 and configured to rotate, and the fork 125 and the knuckle 110 may be connected by the suspension device 130 and the reinforcing structure 150 which will be described below and thus may rotate integrally.

The actuator 121 may be installed to be fixed to the vehicle body S, and the output shaft 122 may be connected to a first fork 126 which will be described below. The actuator 121 may receive power from a power supply such as a battery and generate rotation power for steering of the wheel 10. The actuator 121 may include a steering motor configured to generate the rotation power by electrical energy, and the output shaft 122 may be connected and fixed to operate integrally with the fork 125 and thus may transmit and output the rotation power of the steering motor to the fork 125 and cause steering of the wheel 10 to occur.

The actuator 121 may be installed and disposed above the first fork 126 which will be described below, and the output shaft 122 of the actuator 121 may be connected and fixed to the first fork 126 which will be described below and may be disposed in a direction parallel to the vertical direction. The output shaft 122 of the actuator 121 may have a rotation axis 122a provided to be coaxial with a first axis 151a of the reinforcing structure 150 which will be described below, and this will be described in detail below.

The fork 125 may be connected and fixed to the output shaft 122 of the actuator 121 and rotate. The fork 125 may include the first fork 126 formed to extend in the horizontal direction above the wheel 10 and connected and fixed to the output shaft 122 of the actuator 121 and a second fork 127 formed to extend downward from the first fork 126. By the first fork 126 being disposed above the wheel 10 and the second fork 127 being disposed beside the wheel 10, the actuator 121, the suspension device 130, or the like may function and operate while adjacent to the wheel 10.

The first fork 126 and the second fork 127 may be integrally formed as illustrated in the drawings, but the present disclosure is not limited thereto, and of course, the first fork 126 and the second fork 127 may be manufactured as separate members and then assembled to be handled as a single component.

By the first fork 126 being disposed above the wheel 10 and the output shaft 122 of the actuator 121 being inserted into or fixed to the first fork 126, the first fork 126 may rotate integrally with the output shaft 122 of the actuator 121. In this way, the operation of the actuator 121 may cause the fork 125, the suspension device 130, and the knuckle 110 to rotate, and thus, an operation of steering the wheel 10 may be performed. A damper 131 of the suspension device 130 which will be described below may be rotatably connected to and supported by a lower surface of the first fork 126, and a first support 135 configured to support the other end of a spring 134 of the damper 131 which will be described below may be installed to be fixed to the lower surface of the first fork 126.

The second fork 127 may be formed to extend downward from an inner side end (a right side end based on FIG. 2) of the first fork 126 to face the rotation axis of the wheel 10 or a rear surface (a right side surface based on FIG. 2) of the wheel 10, and the second fork 127 may rotate integrally with the first fork 126. The other end of the upper arm 138 which will be described below may be rotatably connected to an upper side of the second fork 127, and the other end of the lower arm 139 which will be described below may be rotatably connected to a lower side of the second fork 127. Rotation axes of the upper arm 138 and the lower arm 139 relative to the second fork 127 may be disposed parallel to the front-rear direction of the wheel 10, and thus the suspension device 130 can stably absorb and attenuate vibration and impact in the up-down direction that are applied to the wheel 10 from a speed bump on a road or from a damaged road surface. Also, as the other end of the upper arm 138 and the other end of the lower arm 139, which will be described below, are each connected to the second fork 127, the upper arm 138 and the lower arm 139 may be rotated or displaced along with the knuckle 110 and the fork 125, and in this way, the suspension device 130 can stably intervene and operate regardless of a steering angle of the wheel 10.

The suspension device 130 is provided between the steering device 120 and the knuckle 110 and provided to attenuate various vibrations and noises applied from a road surface to the wheel 10. To this end, the suspension device 130 may be provided to include the upper arm 138 and the lower arm 139 which are provided between the knuckle 110 and the fork 125 and the damper 131 which is provided between the fork 125 and the lower arm 139.

The upper arm 138 and the lower arm 139 may connect the knuckle 110 and the fork 125 and may allow the relative displacement between the knuckle 110 and the fork 125. Specifically, the upper arm 138 may have one end rotatably connected to the upper side of the bracket 112 of the knuckle 110 and the other end rotatably connected to the upper side of the second fork 127, and the lower arm 139 may have one end rotatably connected to the lower side of the bracket 112 of the knuckle 110 and the other end rotatably connected to the lower side of the second fork 127. As described above, due to both ends of the upper arm 138 and the lower arm 139 each being rotatably connected to the knuckle 110 and the fork 125, the suspension device 130 can stably intervene and operate regardless of a steering angle of the wheel 10, and due to rotation axes at both ends of the upper arm 138 and the lower arm 139 being disposed parallel to the front-rear direction of the wheel 10, the suspension device 130 can stably absorb and attenuate vibration and impact in the up-down direction that are applied to the wheel 10 from a speed bump on a road or from a damaged road surface.

The upper arm 138 may have a wishbone structure formed in a V-shape so that the damper 131 which will be described below is able to pass through the upper arm 138. That is, due to the one end of the upper arm 138 being rotatably connected to a side surface of the bracket 112 and the other end of the upper arm 138 being rotatably connected to a side surface of the second fork 127, the damper 131 which will be described below may pass through the upper arm 138 and be connected to and supported by the lower arm 139. At least a portion of the one end of the lower arm 139 may enter the inlet of the bracket 112, and the other end of the lower arm 139 may be rotatably connected to a lower end of the second fork 127. The other end of the damper 131 which will be described below may be rotatably connected to the lower arm 139.

In this way, by the upper arm 138 and the lower arm 139 being disposed to constitute a single group in the up-down direction between the bracket 112 of the knuckle 110 and the second fork 127, the relative displacement in the vertical direction or up-down direction is allowed between the knuckle 110 and the fork 125, and simultaneously, the knuckle 110 and the fork 125 are firmly connected so that the knuckle 110 and the fork 125 rotate integrally by rotation power provided from the steering device 120, and stable steering of the wheel 10 is implemented.

One end of the damper 131 may be rotatably supported by the first fork 126, and the other end of the damper 131 may be rotatably supported by the lower arm 139. Specifically, the damper 131 may include a main body 132 of which a lower end is rotatably connected to and supported by the lower arm 139 with a direction parallel to the front-rear direction of the wheel 10 as an axis, a piston rod 133 of which at least one portion is provided to be insertable into the main body 132 and an upper end is rotatably connected to and supported by the first fork 126 with the direction parallel to the front-rear direction of the wheel 10 as an axis, and the spring 134 configured to elastically support the main body 132 and the piston rod 133 relative to each other.

By being provided to have a hydraulic cylinder structure and operating to expand and contract according to a liquid pressure, the main body 132 and the piston rod 133 may absorb and attenuate impact and loads applied to the wheel 10. Also, the lower end of the main body 132 and the upper end of the piston rod 133 may be rotatably connected to and supported by the lower arm 139 and the first fork 126, respectively, and rotation axes thereof may be disposed parallel to the front-rear direction of the wheel 10. Vibration and impact applied to the wheel 10 from a speed bump on a road or from a damaged road surface are mostly generated and transmitted in the up-down direction. Accordingly, by rotation axes at both ends of the damper 131 being disposed in the front-rear direction of the wheel 10 that is orthogonal to the up-down direction of the wheel 10, the vibration and impact applied in the up-down direction can be stably attenuated by the suspension device 130.

The spring 134 may elastically support the main body 132 and the piston rod 133 relative to each other. The spring 134 may be provided in the form of a coil and may be disposed on an outer side of the piston rod 133. One end of the spring 134 may be adhered to and supported by the first support 135 installed to be fixed to the main body 132, and the other end of the spring 134 may be adhered to and supported by a second support 136 installed to be fixed to the first fork 126 or the piston rod 133. Portions of the first and second supports 135 and 136 that come in contact with the spring 134 are formed to be bent, and in this way, the first and second supports 135 and 136 can prevent the spring 134 from falling and stably mount and support the spring 134.

The reinforcing structure 150 is provided between the knuckle 110 and the vehicle body S and provided to, while promoting structural stability despite loads in various directions that are applied to the wheel 10, suppress an increase in the size of an installation space and improve the space utilization of the vehicle.

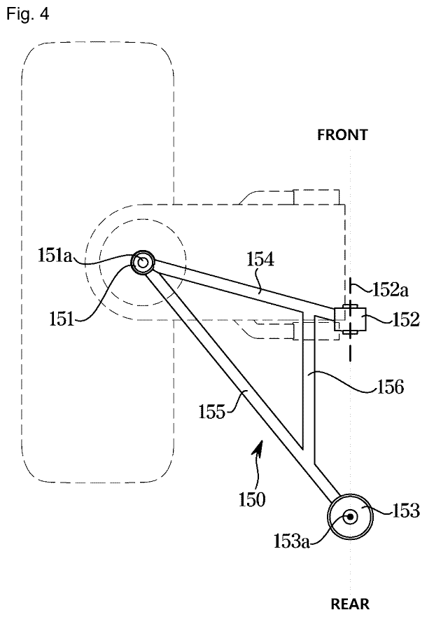

FIG. 4 is a plan view illustrating the wheel module 100 according to the first embodiment of the present disclosure. Referring to FIGS. 1 to 5, the reinforcing structure 150 may be provided to include the first end 151 rotatably connected to the knuckle 110, second and third ends 152 and 153 rotatably connected to the vehicle body S, a first frame 154 configured to connect the first end 151 and the second end 152 to each other, a second frame 155 configured to connect the first end 151 and the third end 153 to each other, and a support frame 156 provided between the first frame 154 and the second frame 155 and configured to reinforce stiffness.

The first end 151 is rotatably connected to the knuckle 110 along the first axis 151a disposed parallel to the vertical direction or up-down direction. The first end 151 may be connected to the lower end of the hub 111 of the knuckle 110 to suppress an increase in the size of the wheel module 100, and the first axis 151a may be provided to be coaxial with the rotation axis 122a of the output shaft 122. As illustrated in FIG. 3, as the rotation axis 122a of the output shaft 122 of the actuator 121 and the first axis 151a of the first end 151 are provided to be coincident and coaxial with each other, the rotation axis 122a of the output shaft 122 and the first axis 151a of the first end 151 may together constitute a kingpin of the steering device 120. In this way, steering of the wheel 10 is stably performed during the operation of the steering device 120, and simultaneously, some of the load applied to the fork 125 and the knuckle 110 during steering is absorbed and distributed by the first end 151 of the reinforcing structure 150. As a result, the structural stability of the wheel module 100 can be improved.

The second end 152 may be rotatably connected to the vehicle body S along a second axis 152a disposed parallel to the longitudinal direction of the vehicle body S. The second end 152 may be connected to the first end 151 by the first frame 154, and to this end, the first end 151 may be disposed at one end of the first frame 154, and the second end 152 may be disposed at the other end of the first frame 154. By being rotatably connected to and supported by the vehicle body S along the second axis 152a parallel to the longitudinal direction of the vehicle body S, the second end 152 may bear a load in a transverse direction orthogonal to the second axis 152a, in other words, a load applied in the width direction of the vehicle body S to the wheel 10 or the wheel module 100. The first frame 154 may be formed to extend in a direction parallel to the width direction of the vehicle body S or a direction corresponding to the width direction to more stably bear the load in the transverse direction that is applied to the wheel 10 or the wheel module 100.

The third end 153 may be rotatably connected to the vehicle body S along a third axis 153a disposed parallel to the vertical direction or up-down direction. The third end 153 may be connected to the first end 151 by the second frame 155, and to this end, the first end 151 may be disposed at one end of the second frame 155, and the third end 153 may be disposed at the other end of the second frame 155. By being rotatably connected to and supported by the vehicle body S along the third axis 153a parallel to the vertical direction or up-down direction of the vehicle body S, the third end 153 may bear a load in a longitudinal direction orthogonal to the third axis 153a, in other words, a load applied in the longitudinal direction of the vehicle body S to the wheel 10 or the wheel module 100.

Meanwhile, generally, the number of times and amount of time a vehicle is driven forward are relatively larger than the number of times and amount of time the vehicle is driven rearward, and during forward driving, the speed of the vehicle is high, and thus a load applied to the wheel 10 or the wheel module 100 is greater. That is, during forward driving of the vehicle, the longitudinal load applied to the wheel 10 or the wheel module 100 is mostly applied to the rear of the vehicle body S. Accordingly, the third end 153 may be disposed behind the second end 152 in the vehicle body S. Further, the second frame 155 may be formed to extend to be inclined toward the rear of the vehicle body S to more stably bear the longitudinal load toward the rear that is applied to the wheel 10 or the wheel module 100. As a result, the second frame 155 may be disposed at a certain angle with respect to the first frame 154.

In this way, since the second end 152 and the third end 153 of the reinforcing structure 150 are each rotatably connected to the vehicle body S, and the rotation axis (second axis) of the second end 152 and the rotation axis (third axis) of the third end 153 are disposed orthogonal to each other, loads in various directions that are applied to the wheel 10 or the wheel module 100 can be stably absorbed and distributed, and thus the structural stability of the wheel module 100 and operational reliability of various devices can be improved.

As illustrated in FIGS. 2 and 3, the second end 152 and the third end 153 of the reinforcing structure 150 may be disposed and connected at the same height on the vehicle body S to, in a case in which a load is applied to the wheel 10 or the wheel module 100, prevent the load from being concentrated to one portion. Alternatively, as illustrated in FIG. 4, the second end 152 and the third end 153 of the reinforcing structure 150 may be disposed on the same phase based on the longitudinal direction of the vehicle body S to prevent the load from being concentrated to one portion and evenly transmit and distribute the load toward the vehicle body S. In this way, despite loads applied in various directions during traveling of the vehicle or steering of the wheel 10, a load may be prevented from being concentrated to one point of the reinforcing structure 150 to promote the structural stability of the reinforcing structure 150 and the wheel module 100, and a load applied to the vehicle body S via the second and third ends 152 and 153 of the reinforcing structure 150 may also be prevented from being concentrated to improve the structural stability of the vehicle body S and the durability of the vehicle.

The reinforcing structure 150 may have the support frame 156 provided between the first frame 154 and the second frame 155 to further reinforce the stiffness. The support frame 156 may have one end connected to the first frame 154 and the other end connected to the second frame 155, and an extending direction of the support frame 156 may be different from extending directions of the first and second frames 154 and 155 to easily distribute loads applied in various directions. As an example, in a case in which the first frame 154 extends in a direction corresponding to the width direction of the vehicle body S and the second frame 155 is formed to extend to be inclined toward the rear of the vehicle body S, the support frame 156 may be formed to extend in the longitudinal direction of the vehicle body S so that the first and second frames 154 and 155 and the support frame 156 are disposed in directions different from each other, and in this way, loads in various directions that are applied to the wheel 10 or the wheel module 100 can be stably borne, and the loads can be transmitted and distributed to surrounding members.

Hereinafter, the wheel module 200 according to a second embodiment of the present disclosure will be described.

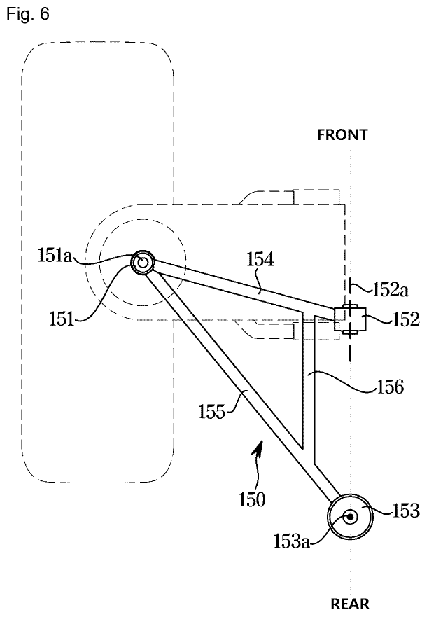

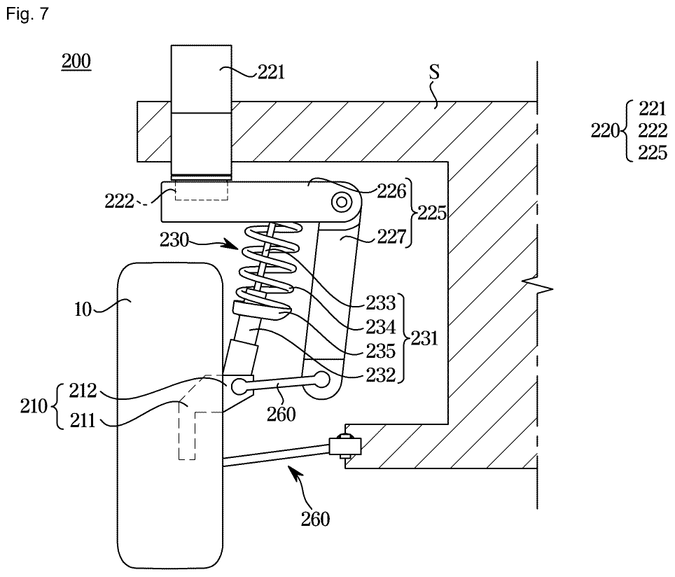

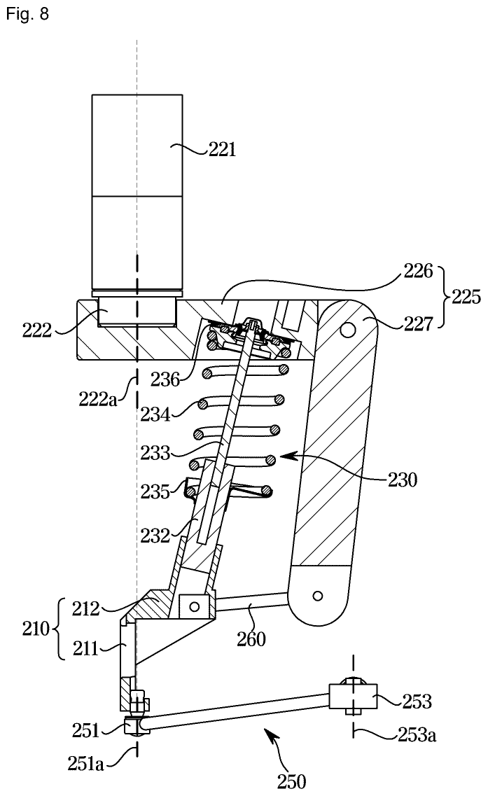

FIGS. 6 to 9 are views illustrating the wheel module 200 according to the second embodiment of the present disclosure. Specifically, FIGS. 6 and 7 are a perspective view and a lateral view illustrating the wheel module 200 according to the second embodiment of the present disclosure, and FIG. 8 is a lateral cross-sectional view illustrating the wheel module 200 according to the second embodiment of the present disclosure.

In the following description of the wheel module 200 according to the second embodiment of the present disclosure, except for a case in which an additional description is given using reference numerals different from above, the description is the same as the above-given description of the wheel module 100 according to the first embodiment, and such descriptions will be omitted to avoid redundancy of the content.

Referring to FIGS. 6 to 8, the wheel module 200 according to the second embodiment of the present disclosure is provided to include a driving device installed on an inner side of the wheel 10 of a vehicle and configured to provide a rotational force of the wheel 10, a braking device configured to control a rotational speed of the wheel 10 and brake the vehicle, a steering device 220 configured to steer the wheel 10, a suspension device 230 configured to absorb and reduce vibration, noise, and the like transmitted from a road surface to the wheel 10, a knuckle 210 configured to rotatably support the wheel 10, a first reinforcing structure 250 provided between the knuckle 210 and the vehicle body S to increase the stiffness of the wheel module 200, and a second reinforcing structure 260 provided between the knuckle 210 and a fork 225 to increase the stiffness of the wheel module 200.

The vehicle body S which will be described below is a part of a vehicle and may be understood as a concept encompassing various fixtures or fixed portions that can stably support components such as a chassis.

The wheel 10 may be provided as a plurality of wheels 10 installed on a vehicle, and the wheel module 200 according to the second embodiment of the present disclosure may be provided on each of the plurality of wheels 10. The wheel 10 may rotate while in contact with a road surface and thus cause the vehicle to move, and the wheel 10 may include a rim 11 having an outer peripheral portion along which a tire is installed and at least one spoke 12 connected to the rim 11 to rotate along with the rim 11 and form an exterior of the wheel 10. The driving device configured to provide a rotational force to the wheel 10 and cause the vehicle to travel and the braking device configured to control the rotational speed of the wheel 10 and brake the vehicle may be disposed on a mounting portion 15 at an inner side that is formed by the rim 11 and the spoke 12.

A driving device 290 may be provided on an inner side of the mounting portion 15 of the wheel 10 and may receive power from a power supply such as a battery and generate rotation power for rotation of the wheel 10. The driving device may include a driving motor (not illustrated) configured to generate the rotation power by electrical energy, and the driving motor may include a rotor installed to be fixed to the spoke 12, a rotator installed to be fixed to the rotor and having a magnetic force, and a stator provided to face the rotator and having a magnetic force. However, this is only an example to help understanding the present disclosure, and the present disclosure is not limited thereto. As long as the driving device is disposed on the inner side of the wheel 10 and may receive power and cause the wheel 10 to rotate and the vehicle to move, the driving device may be understood to be the same as above even in a case in which the driving device is provided as a device of various other methods and structures.

The braking device (not illustrated) may be provided on the inner side of the mounting portion 15 of the wheel 10 like the driving device and may suppress the rotation of the wheel 10 and perform braking of the vehicle. The braking device may be provided as a device of various methods that is configured to receive power from a power supply such as a battery and control the rotational speed of the wheel 10. As an example, the braking device may, by a structure made of a nut and a spindle and configured to convert a rotational force of a braking motor configured to generate power into linear motion, approach and move away from the rim 11 to control the rotational speed of the wheel 10. In addition, the braking device may use a piston, configured to move back and forth by the power of the braking motor, to generate a liquid pressure in a pressurizing medium and transmit the liquid pressure to a cylinder provided at the wheel 10 to control the rotational speed of the wheel 10. However, the present disclosure is not limited thereto, and of course, as long as the braking device is disposed on the inner side of the wheel 10 and may receive power and control the rotational speed of the wheel 10 to perform braking of the vehicle, the braking device according to the present embodiment may be provided as a device of various other methods and structures.

At least any one of the driving device and the braking device may be rotatably supported by and connected to the knuckle 210 and thus be supported by the vehicle body S, and the knuckle 210 may rotatably support the wheel 10 via the driving device or the braking device. Also, by being provided to connect the wheel 10 to the steering device 220 and the suspension device 230 which will be described below, the knuckle 210 may transmit an operation of the steering device 220 to the wheel 10 to perform steering of the wheel 10 or may transmit vibration and noise applied from a road surface to the wheel 10 to the suspension device 230 to induce attenuation of the vibration and noise.

The knuckle 210 may include a hub 211 connected to at least any one of the driving device and the braking device and a bracket 212 formed to extend from an inner side end (a right side end based on FIG. 7) of the hub 211 and connected to the steering device 220 and the suspension device 230 which will be described below.

An outer side end (a left side end based on FIG. 7) of the hub 211 may rotatably support the wheel 10 via the driving device or the braking device, and in order to promote weight reduction and simplify the structure, the hub 211 may be provided in the shape of a ring and may be disposed to be coaxial with a rotation axis of the wheel 10. A first end 251 of the first reinforcing structure 250 which will be described below may be rotatably connected to a lower end of the hub 211, and this will be described in detail below.

The bracket 212 may be formed to extend or expand toward one side from the inner side end of the hub 211. An accommodator in which a main body 232 of a damper 231 which will be described below is inserted and installed may be formed to be recessed in an upper side of the bracket 212, and one end of the second reinforcing structure 260 which will be described below may be rotatably connected to the upper side of the bracket 212. A rotation axis of the second reinforcing structure 260 relative to the bracket 212 may be disposed parallel to the front-rear direction of the wheel 10. Since vibration and impact applied to the wheel 10 from a speed bump on a road or from a damaged road surface are mostly generated and transmitted in the up-down direction, the rotation axis of the second reinforcing structure 260 relative to the bracket 212 may be disposed in the front-rear direction orthogonal to the up-down direction of the wheel 10 so that the vibration and impact in the up-down direction can be stably absorbed and attenuated by the suspension device 230. Also, as the one end of the second reinforcing structure 260 which will be described below is connected to the bracket 212, the second reinforcing structure 260 may be rotated or displaced along with the knuckle 210, and in this way, the suspension device 230 can stably intervene and operate regardless of a steering angle of the wheel 10. Further, by the second reinforcing structure 260 transmitting and distributing impact and vibration applied from a road surface to the wheel 10 toward a fork link 227 which will be described below, a load can be prevented from being concentrated to one portion.

The steering device 220 is provided to rotate the knuckle 210 and the wheel 10 connected thereto to steer the wheel 10.

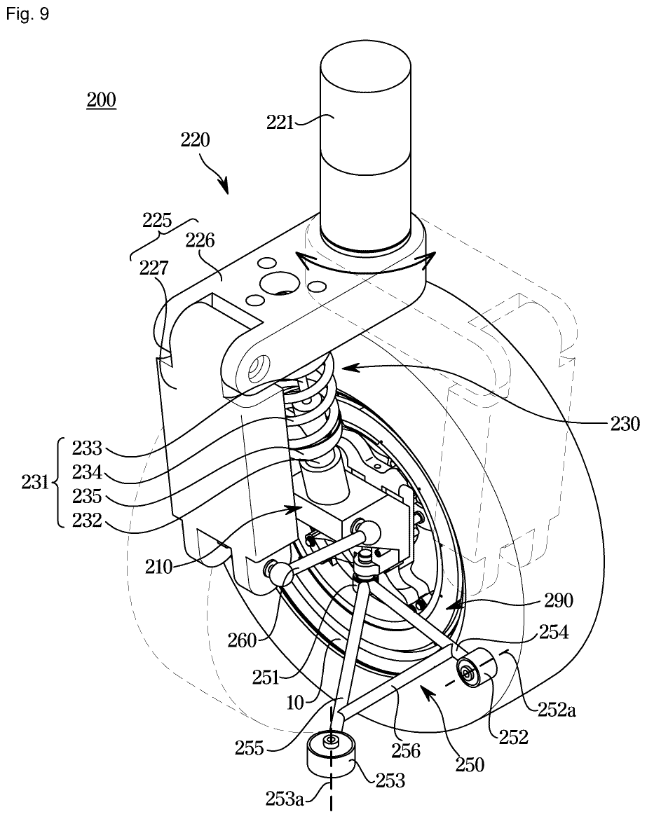

FIG. 9 is a perspective view illustrating an operational state in which the wheel 10 is steered by the steering device 220. Referring to FIGS. 6 to 9, the steering device 220 may include an actuator 221 configured to provide rotation power for steering of the wheel 10 and the fork 225 connected to an output shaft 222 of the actuator 221 and configured to rotate, and the fork 225 and the knuckle 210 may be connected by the suspension device 230 and the second reinforcing structure 260 which will be described below and thus may rotate integrally.

The actuator 221 may be installed to be fixed to the vehicle body S, and the output shaft 222 may be connected to a fork body 226 which will be described below. The actuator 221 may receive power from a power supply such as a battery and generate rotation power for steering of the wheel 10. The actuator 221 may include a steering motor configured to generate the rotation power by electrical energy, and the output shaft 222 may be connected and fixed to operate integrally with the fork 225 and thus may transmit and output the rotation power of the steering motor to the fork 225 and cause steering of the wheel 10 to occur.

The actuator 221 may be installed and disposed above the fork body 226 which will be described below, and the output shaft 222 of the actuator 221 may be connected and fixed to the fork body 226 which will be described below and may be disposed in a direction parallel to the vertical direction. The output shaft 222 of the actuator 221 may have a rotation axis 222a provided to be coaxial with a first axis 251a of the first reinforcing structure 250 which will be described below, and this will be described in detail below.

The fork 225 may be connected and fixed to the output shaft 222 of the actuator 221 and rotate. The fork 225 may include the fork body 226 formed to extend in the horizontal direction above the wheel 10 and connected and fixed to the output shaft 222 of the actuator 221 and the fork link 227 rotatably connected to and formed to extend downward from an inner side end (a right side end based on FIG. 7) of the fork body 226. By the fork body 226 being disposed above the wheel 10 and the fork link 227 being disposed beside the wheel 10, the actuator 221, the suspension device 230, or the like may function and operate while adjacent to the wheel 10.

The fork body 226 may be disposed above the wheel 10, and the actuator 221 may be installed at the fork body 226. Specifically, by the output shaft 222 of the actuator 221 being inserted into or fixed to the fork body 226, the fork body 226 may rotate integrally with the output shaft 222 of the actuator 221. In this way, the operation of the actuator 221 may cause the fork 225, the suspension device 230, the second reinforcing structure 260, and the knuckle 210 to rotate, and thus, an operation of steering the wheel 10 may be performed. The damper 231 of the suspension device 230 which will be described below may be connected to and supported by a lower surface of the fork body 226, and a first support 235 configured to support the other end of a spring 234 of the damper 231 which will be described below may be installed to be fixed to the lower surface of the fork body 226.

The fork link 227 may be rotatably connected to the inner side end (the right side end based on FIG. 7) of the fork body 226 and may be formed to extend downward therefrom to face the rotation axis of the wheel 10 or a rear surface (a right side surface based on FIG. 7) of the wheel 10. The fork body 226 and the fork link 227 may rotate integrally by the operation of the actuator 221 and may be rotatably connected to each other with a direction parallel to the front-rear direction of the wheel 10 as a rotation axis. In this way, during attenuation of impact and vibration by the suspension device 230 which will be described below, loads applied to the fork 225 can be stably absorbed and borne, and since a flexible operation of the fork 225 becomes possible, performance of attenuating impact and vibration by the suspension device 230 can be improved.

The other end of the second reinforcing structure 260 which will be described below may be rotatably connected to a lower side of the fork link 227. A rotation axis of the second reinforcing structure 260 relative to the fork link 227 may be disposed parallel to the front-rear direction of the wheel 10, and thus the suspension device 230 can stably absorb and attenuate vibration and impact in the up-down direction that are applied to the wheel 10 from a speed bump on a road or from a damaged road surface. Also, as the suspension device 230 is rotated or displaced along with the knuckle 210 and the fork 225, the suspension device 230 can stably intervene and operate regardless of a steering angle of the wheel 10. Further, by the impact and vibration applied from a road surface to the wheel 10 being transmitted and distributed toward the fork link 227 by the second reinforcing structure 260, a load can be prevented from being concentrated to one portion.

The suspension device 230 is provided between the steering device 220 and the knuckle 210 and provided to attenuate various vibrations and noises applied from a road surface to the wheel 10. To this end, the suspension device 230 may be provided to include the damper 231 provided between the fork body 226 and the bracket 212.

One end of the damper 231 may be rotatably supported by the fork body 226, and the other end of the damper 231 may be supported by the bracket 212 of the knuckle 210. Specifically, the damper 231 may include the main body 232 of which a lower end is supported by the bracket 212, a piston rod 233 of which at least one portion is provided to be insertable into the main body 232 and an upper end is supported by the fork body 226, and the spring 234 configured to elastically support the main body 232 and the piston rod 233 relative to each other.

By being provided to have a hydraulic cylinder structure, the main body 232 and the piston rod 233 may, according to a liquid pressure, absorb and attenuate impact and loads applied to the wheel 10. Also, the lower end of the main body 232 is inserted into and supported by the accommodator formed to be recessed in the bracket 212 of the knuckle 210, and the upper end of the piston rod 233 is supported by the fork body 226, and thus the main body 232 and the piston rod 233 may, by operating to expand and contract in the up-down direction, absorb and attenuate vibration and impact applied from a road surface to the wheel 10. Also, by rotating along with the fork body 226 and the knuckle 210 during the operation of the steering device 220, the main body 232 and the piston rod 233 can stably absorb the impact and vibration applied from a road surface to the wheel 10 regardless of a steering angle of the wheel 10.

The spring 234 may elastically support the main body 232 and the piston rod 233 relative to each other. The spring 234 may be provided in the form of a coil and may be disposed on an outer side of the piston rod 233. One end of the spring 234 may be adhered to and supported by the first support 235 installed to be fixed to the main body 232, and the other end of the spring 234 may be adhered to and supported by a second support 236 installed to be fixed to the fork body 226 or the piston rod 233. Portions of the first and second supports 235 and 236 that come in contact with the spring 234 are formed to be bent, and in this way, the first and second supports 235 and 236 may prevent the spring 234 from falling and stably mount and support the spring 234.

The first and second reinforcing structures 250 and 260 are provided to, while promoting structural stability despite loads in various directions that are applied to the wheel 10, suppress an increase in the size of an installation space and improve the space utilization of the vehicle. The first reinforcing structure 250 may be provided between the knuckle 210 and the vehicle body S, and the second reinforcing structure 260 may be provided between the knuckle 210 and the fork 225.

The first reinforcing structure 250 may be provided to include the first end 251 rotatably connected to the knuckle 210, second and third ends 252 and 253 rotatably connected to the vehicle body S, a first frame 254 configured to connect the first end 251 and the second end 252 to each other, a second frame 255 configured to connect the first end 251 and the third end 253 to each other, and a support frame 256 provided between the first frame 254 and the second frame 255 and configured to reinforce stiffness.

The first end 251 is rotatably connected to the knuckle 210 along the first axis 251a disposed parallel to the vertical direction or up-down direction. The first end 251 may be connected to the lower end of the hub 211 of the knuckle 210 to suppress an increase in the size of the wheel module 200, and the first axis 251a may be provided to be coaxial with the rotation axis 222a of the output shaft 222. As illustrated in FIG. 8, as the rotation axis 222a of the output shaft 222 of the actuator 221 and the first axis 251a of the first end 251 are provided to be coincident and coaxial with each other, the rotation axis 222a of the output shaft 222 of the actuator 221 and the first axis 251a of the first end 251 may together constitute a kingpin of the steering device 220. In this way, steering of the wheel 10 is stably performed during the operation of the steering device 220, and simultaneously, some of the load applied to the fork 225 and the knuckle 210 during steering is absorbed and distributed by the first end 251 of the first reinforcing structure 250. As a result, the structural stability of the wheel module 200 can be improved.

The second end 252 may be rotatably connected to the vehicle body S along a second axis 252a disposed parallel to the longitudinal direction of the vehicle body S. The second end 252 may be connected to the first end 251 by the first frame 254, and to this end, the first end 251 may be disposed at one end of the first frame 254, and the second end 252 may be disposed at the other end of the first frame 254. By being rotatably connected to and supported by the vehicle body S along the second axis 252a parallel to the longitudinal direction of the vehicle body S, the second end 252 may bear a load in a transverse direction orthogonal to the second axis 252a, in other words, a load applied in the width direction of the vehicle body S to the wheel 10 or the wheel module 200. The first frame 254 may be formed to extend in a direction parallel to the width direction of the vehicle body S or a direction corresponding to the width direction to more stably bear the load in the transverse direction that is applied to the wheel 10 or the wheel module 200.

The third end 253 may be rotatably connected to the vehicle body S along a third axis 253a disposed parallel to the vertical direction or up-down direction. The third end 253 may be connected to the first end 251 by the second frame 255, and to this end, the first end 251 may be disposed at one end of the second frame 255, and the third end 253 may be disposed at the other end of the second frame 255. By being rotatably connected to and supported by the vehicle body S along the third axis 253a parallel to the vertical direction or up-down direction of the vehicle body S, the third end 253 may bear a load in a longitudinal direction orthogonal to the third axis 253a, in other words, a load applied in the longitudinal direction of the vehicle body S to the wheel 10 or the wheel module 200.

Meanwhile, generally, the number of times and amount of time a vehicle is driven forward are relatively larger than the number of times and amount of time the vehicle is driven rearward, and during forward driving, the speed of the vehicle is high, and thus a load applied to the wheel 10 or the wheel module 200 is greater. That is, during forward driving of the vehicle, the longitudinal load applied to the wheel 10 or the wheel module 200 is mostly applied to the rear of the vehicle body S. Accordingly, the third end 253 may be disposed behind the second end 252 in the vehicle body S. Further, the second frame 255 may be formed to extend to be inclined toward the rear of the vehicle body S to more stably bear the longitudinal load toward the rear that is applied to the wheel 10 or the wheel module 200. As a result, the second frame 255 may be disposed at a certain angle with respect to the first frame 254.

In this way, since the second end 252 and the third end 253 of the first reinforcing structure 250 are each rotatably connected to the vehicle body S, and the rotation axis (second axis) of the second end 252 and the rotation axis (third axis) of the third end 253 are disposed orthogonal to each other, loads in various directions that are applied to the wheel 10 or the wheel module 200 can be stably absorbed and distributed, and thus the structural stability of the wheel module 200 and operational reliability of various devices can be improved.

The second end 252 and the third end 253 of the first reinforcing structure 250 may be disposed and connected at the same height on the vehicle body S to, in a case in which a load is applied to the wheel 10 or the wheel module 200, prevent the load from being concentrated to one portion. Alternatively, the second end 252 and the third end 253 of the first reinforcing structure 250 may be disposed on the same phase based on the longitudinal direction of the vehicle body S to prevent the load from being concentrated to one portion and evenly transmit and distribute the load toward the vehicle body S. In this way, despite loads applied in various directions during traveling of the vehicle or steering of the wheel 10, a load can be prevented from being concentrated to one point of the first reinforcing structure 250 to promote the structural stability of the first reinforcing structure 250 and the wheel module 200, and a load applied to the vehicle body S via the second and third ends 252 and 253 of the first reinforcing structure 250 can also be prevented from being concentrated to improve the structural stability of the vehicle body S and the durability of the vehicle.

The first reinforcing structure 250 may have the support frame 256 provided between the first frame 254 and the second frame 255 to further reinforce the stiffness. The support frame 256 may have one end connected to the first frame 254 and the other end connected to the second frame 255, and an extending direction of the support frame 256 may be different from extending directions of the first and second frames 254 and 255 to easily distribute loads applied in various directions. As an example, in a case in which the first frame 254 extends in a direction corresponding to the width direction of the vehicle body S and the second frame 255 is formed to extend to be inclined toward the rear of the vehicle body S, the support frame 256 may be formed to extend in the longitudinal direction of the vehicle body S so that the first and second frames 254 and 255 and the support frame 256 are disposed in directions different from each other, and in this way, loads in various directions that are applied to the wheel 10 or the wheel module 200 can be stably borne, and the loads can be transmitted and distributed to surrounding members.

The second reinforcing structure 260 may be interposed between the bracket 212 of the knuckle 210 and the fork link 227 to connect the knuckle 210 and the fork 225 and may allow the relative displacement between the knuckle 210 and the fork 225. Specifically, the second reinforcing structure 260 may have one end rotatably connected to the bracket 212 of the knuckle 210 and the other end rotatably connected to a lower end of the fork link 227, and rotation axes at both ends of the second reinforcing structure 260 may be disposed parallel to the front-rear direction of the wheel 10 as described above.

The second reinforcing structure 260 may be provided as a pair of second reinforcing structures 260, and the pair of second reinforcing structures 260 may be connected to side portions of the bracket 212 and the fork link 227. That is, by the pair of second reinforcing structures 260 having one end rotatably connected to a side surface of the bracket 212 and the other end rotatably connected to a side surface of the fork link 227, a structure may be formed in which the knuckle 210 and the damper 231 pass through a space formed between the pair of second reinforcing structures 260 when the relative displacement between the knuckle 210 and the fork 225 occurs due to compression of the damper 231.

In this way, while firmly connecting the knuckle 210 and the fork 225 so that the knuckle 210 and the fork 225 rotate integrally by rotation power provided from the steering device 220 and thus stable steering of the wheel 10 is implemented, the second reinforcing structure 260 may transmit and distribute a load applied from a road surface to the wheel 10 to the fork 225 to prevent the load from being concentrated. Further, by the second reinforcing structure 260 being rotatably connected to each of the knuckle 210 and the fork 225 and thus allowing the relative displacement in the vertical direction or up-down direction between the knuckle 210 and the fork 225 and transmitting vibration and impact applied from a road surface to the wheel 10 to the damper 231, the riding comfort of the vehicle can be improved.

Hereinafter, the wheel module 300 according to a third embodiment of the present disclosure will be described.

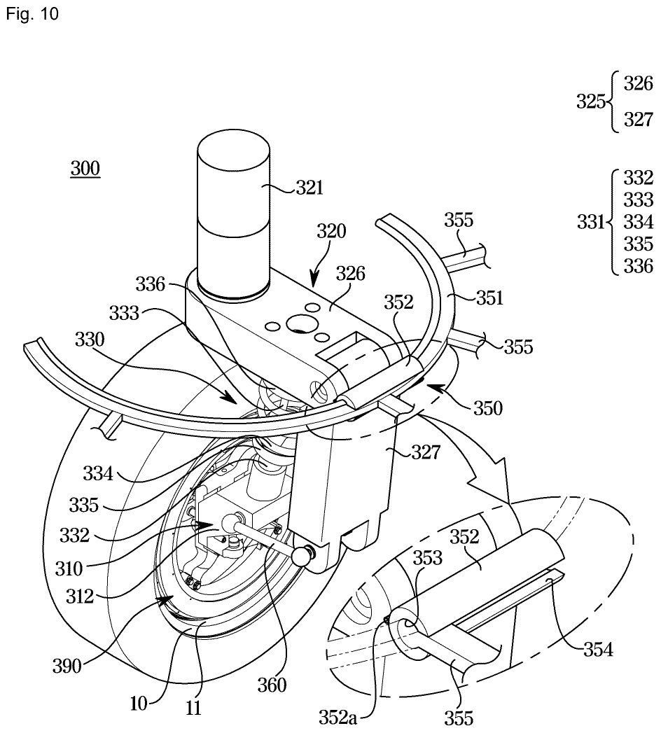

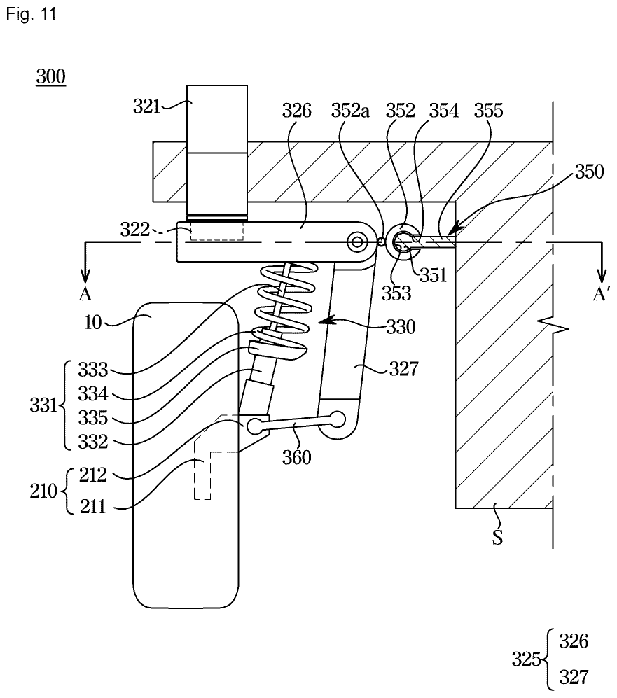

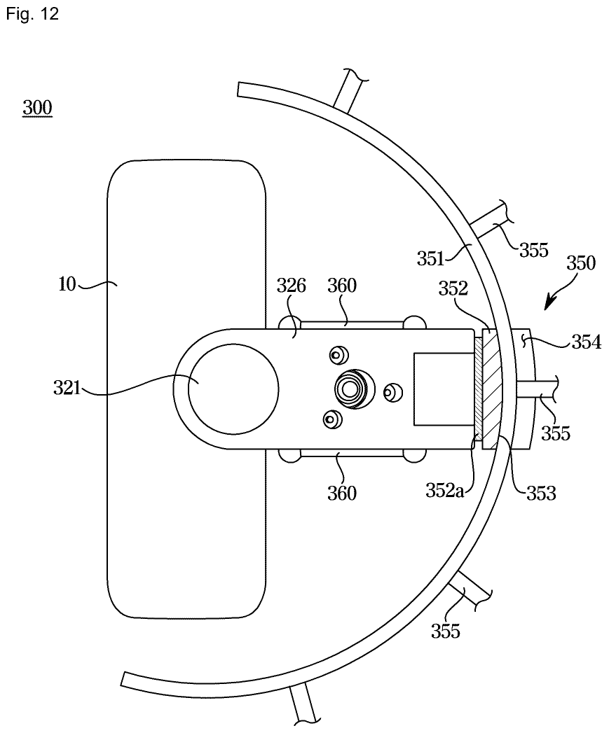

FIGS. 10 to 13 are views illustrating the wheel module 300 according to the third embodiment of the present disclosure. Specifically, FIGS. 10 and 11 are a perspective view and a lateral view illustrating the wheel module 300 according to the third embodiment of the present disclosure, and FIG. 12 is a cross-sectional view taken along line A-A′ of FIG. 11.

In the following description of the wheel module 300 according to the third embodiment of the present disclosure, except for a case in which an additional description is given using reference numerals different from above, the description is the same as the above-given description of the wheel module 200 according to the second embodiment, and such descriptions will be omitted to avoid redundancy of the content.

Referring to FIGS. 10 to 12, the wheel module 300 according to the third embodiment of the present disclosure is provided to include a driving device installed on an inner side of the wheel 10 of a vehicle and configured to provide a rotational force of the wheel 10, a braking device configured to control a rotational speed of the wheel 10 and brake the vehicle, a steering device 320 configured to steer the wheel 10, a suspension device 330 configured to absorb and reduce vibration, noise, and the like transmitted from a road surface to the wheel 10, a knuckle 310 configured to rotatably support the wheel 10, a first reinforcing structure 350 provided between a fork 325 and the vehicle body S to increase the stiffness of the wheel module 300, and a second reinforcing structure 360 provided between the knuckle 310 and the fork 325 to increase the stiffness of the wheel module 300.

The vehicle body S which will be described below is a part of a vehicle and may be understood as a concept encompassing various fixtures or fixed portions that can stably support components such as a chassis.

The wheel 10 may be provided as a plurality of wheels 10 installed on a vehicle, and the wheel module 300 according to the third embodiment of the present disclosure may be provided on each of the plurality of wheels 10. The wheel 10 may rotate while in contact with a road surface and thus cause the vehicle to move, and the wheel 10 may include a rim 11 having an outer peripheral portion along which a tire is installed and at least one spoke 12 connected to the rim 11 to rotate along with the rim 11 and form an exterior of the wheel 10. The driving device configured to provide a rotational force to the wheel 10 and cause the vehicle to travel and the braking device configured to control the rotational speed of the wheel 10 and brake the vehicle may be disposed on a mounting portion 15 at an inner side that is formed by the rim 11 and the spoke 12.

A driving device 390 may be provided on an inner side of the mounting portion 15 of the wheel 10 and may receive power from a power supply such as a battery and generate rotation power for rotation of the wheel 10. The driving device may include a driving motor (not illustrated) configured to generate the rotation power by electrical energy, and the driving motor may include a rotor installed to be fixed to the spoke 12, a rotator installed to be fixed to the rotor and having a magnetic force, and a stator provided to face the rotator and having a magnetic force. However, this is only an example to help understanding the present disclosure, and the present disclosure is not limited thereto. As long as the driving device is disposed on the inner side of the wheel 10 and may receive power and cause the wheel 10 to rotate and the vehicle to move, the driving device may be understood to be the same as above even in a case in which the driving device is provided as a device of various other methods and structures.

The braking device (not illustrated) may be provided on the inner side of the mounting portion 15 of the wheel 10 like the driving device and may suppress the rotation of the wheel 10 and perform braking of the vehicle. The braking device may be provided as a device of various methods that is configured to receive power from a power supply such as a battery and control the rotational speed of the wheel 10. As an example, the braking device may, by a structure made of a nut and a spindle and configured to convert a rotational force of a braking motor configured to generate power into linear motion, approach and move away from the rim 11 to control the rotational speed of the wheel 10. In addition, the braking device may use a piston, configured to move back and forth by the power of the braking motor, to generate a liquid pressure in a pressurizing medium and transmit the liquid pressure to a cylinder provided at the wheel 10 to control the rotational speed of the wheel 10. However, the present disclosure is not limited thereto, and of course, as long as the braking device is disposed on the inner side of the wheel 10 and may receive power and control the rotational speed of the wheel 10 to perform braking of the vehicle, the braking device according to the present embodiment may be provided as a device of various other methods and structures.

At least any one of the driving device and the braking device may be rotatably supported by and connected to the knuckle 310 and thus be supported by the vehicle body S, and the knuckle 310 may rotatably support the wheel 10 via the driving device or the braking device. Also, by being provided to connect the wheel 10 to the steering device 320 and the suspension device 330 which will be described below, the knuckle 310 may transmit an operation of the steering device 320 to the wheel 10 to perform steering of the wheel 10 or may transmit vibration and noise applied from a road surface to the wheel 10 to the suspension device 330 to induce attenuation of the vibration and noise.

The knuckle 310 may include a hub 311 connected to at least any one of the driving device and the braking device and a bracket 312 formed to extend from an inner side end (a right side end based on FIG. 11) of the hub 311 and connected to the steering device 320 and the suspension device 330 which will be described below.

An outer side end (a left side end based on FIG. 11) of the hub 311 may rotatably support the wheel 10 via the driving device or the braking device, and in order to promote weight reduction and simplify the structure, the hub 311 may be provided in the shape of a ring and may be disposed to be coaxial with a rotation axis of the wheel 10.

The bracket 312 may be formed to extend or expand toward one side from the inner side end of the hub 311. An accommodator in which a main body 332 of a damper 331 which will be described below is inserted and installed may be formed to be recessed in an upper side of the bracket 312, and one end of the second reinforcing structure 360 which will be described below may be rotatably connected to the upper side of the bracket 312. A rotation axis of the second reinforcing structure 360 relative to the bracket 312 may be disposed parallel to the front-rear direction of the wheel 10. Since vibration and impact applied to the wheel 10 from a speed bump on a road or from a damaged road surface are mostly generated and transmitted in the up-down direction, the rotation axis of the second reinforcing structure 360 relative to the bracket 312 may be disposed in the front-rear direction orthogonal to the up-down direction of the wheel 10 so that the vibration and impact in the up-down direction can be stably absorbed and attenuated by the suspension device 330. Also, as the one end of the second reinforcing structure 360 which will be described below is connected to the bracket 312, the second reinforcing structure 360 may be rotated or displaced along with the knuckle 310, and in this way, the suspension device 330 can stably intervene and operate regardless of a steering angle of the wheel 10. Further, by the second reinforcing structure 360 transmitting and distributing impact and vibration applied from a road surface to the wheel 10 toward a fork link 327 which will be described below, a load can be prevented from being concentrated to one portion. The steering device 320 is provided to rotate the knuckle 310 and the wheel 10 connected thereto to steer the wheel 10.

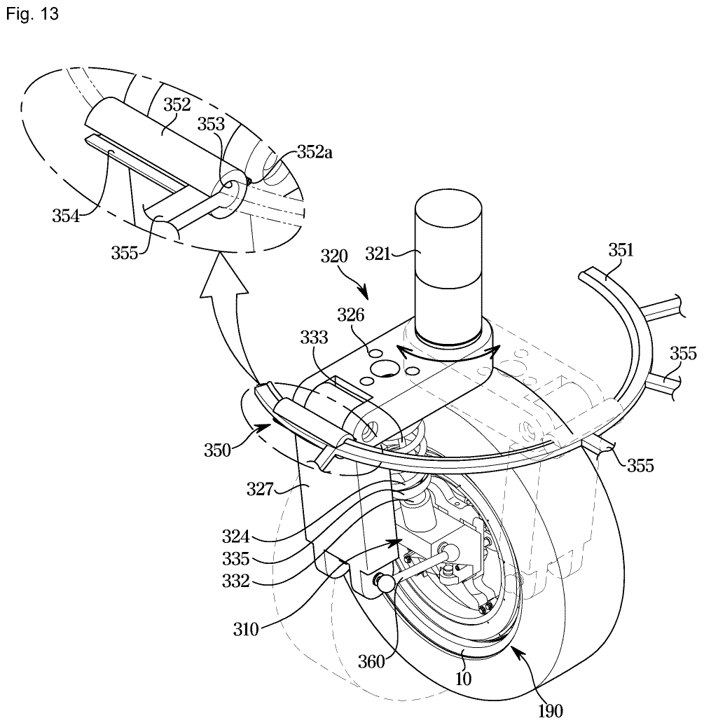

FIG. 13 is a perspective view illustrating an operational state in which the wheel 10 is steered by the steering device 320. Referring to FIGS. 10 to 13, the steering device 320 may include an actuator 321 configured to provide rotation power for steering of the wheel 10 and the fork 325 connected to an output shaft 322 of the actuator 321 and configured to rotate, and the fork 325 and the knuckle 310 may be connected by the suspension device 330 and the second reinforcing structure 360 which will be described below and thus may rotate integrally.

The actuator 321 may be installed to be fixed to the vehicle body S, and the output shaft 322 may be connected to a fork body 326 which will be described below. The actuator 321 may receive power from a power supply such as a battery and generate rotation power for steering of the wheel 10. The actuator 321 may include a steering motor configured to generate the rotation power by electrical energy, and the output shaft 322 may be connected and fixed to operate integrally with the fork 325 and thus may transmit and output the rotation power of the steering motor to the fork 325 and cause steering of the wheel 10 to occur.

The actuator 321 may be installed and disposed above the fork body 326 which will be described below, and the output shaft 322 of the actuator 321 may be connected and fixed to the fork body 326 which will be described below and may be disposed in a direction parallel to the vertical direction. The fork 325 may be connected and fixed to the output shaft 322 of the actuator 321 and rotate. The fork 325 may include the fork body 326 formed to extend in the horizontal direction above the wheel 10 and connected and fixed to the output shaft 322 of the actuator 321 and the fork link 327 rotatably connected to and formed to extend downward from an inner side end (a right side end based on FIG. 11) of the fork body 326. By the fork body 326 being disposed above the wheel 10 and the fork link 327 being disposed beside the wheel 10, the actuator 321, the suspension device 330, or the like may function and operate while adjacent to the wheel 10.

The fork body 326 may be disposed above the wheel 10, and the actuator 321 may be installed at the fork body 326. Specifically, by the output shaft 322 of the actuator 321 being inserted into or fixed to the fork body 326, the fork body 326 may rotate integrally with the output shaft 322 of the actuator 321. In this way, the operation of the actuator 321 may cause the fork 325, the suspension device 330, the second reinforcing structure 360, and the knuckle 310 to rotate, and thus, an operation of steering the wheel 10 may be performed. The damper 331 of the suspension device 330 which will be described below may be connected to and supported by a lower surface of the fork body 326, and a first support 335 configured to support the other end of a spring 334 of the damper 331 which will be described below may be installed to be fixed to the lower surface of the fork body 326.

The fork link 327 may be rotatably connected to the inner side end (the right side end based on FIG. 11) of the fork body 326 and may be formed to extend downward therefrom to face the rotation axis of the wheel 10 or a rear surface (a right side surface based on FIG. 11) of the wheel 10. The fork body 326 and the fork link 327 may rotate integrally by the operation of the actuator 321 and may be rotatably connected to each other with a direction parallel to the front-rear direction of the wheel 10 as a rotation axis. In this way, during attenuation of impact and vibration by the suspension device 330 which will be described below, loads applied to the fork 325 can be stably absorbed and borne, and since a flexible operation of the fork 325 becomes possible, performance of attenuating impact and vibration by the suspension device 330 can be improved.

The other end of the second reinforcing structure 360 which will be described below may be rotatably connected to a lower side of the fork link 327. A rotation axis of the second reinforcing structure 360 relative to the fork link 327 may be disposed parallel to the front-rear direction of the wheel 10, and thus the suspension device 330 can stably absorb and attenuate vibration and impact in the up-down direction that are applied to the wheel 10 from a speed bump on a road or from a damaged road surface. Also, as the suspension device 330 is rotated or displaced along with the knuckle 310 and the fork 325, the suspension device 330 can stably intervene and operate regardless of a steering angle of the wheel 10. Further, by the impact and vibration applied from a road surface to the wheel 10 being transmitted and distributed toward the fork link 327 by the second reinforcing structure 360, a load can be prevented from being concentrated to one portion.

The suspension device 330 is provided between the steering device 320 and the knuckle 310 and provided to attenuate various vibrations and noises applied from a road surface to the wheel 10. To this end, the suspension device 330 may be provided to include the damper 331 provided between the fork body 326 and the bracket 312.

One end of the damper 331 may be supported by the fork body 326, and the other end of the damper 331 may be supported by the bracket 312 of the knuckle 310. Specifically, the damper 331 may include the main body 332 of which a lower end is supported by the bracket 312, a piston rod 333 of which at least one portion is provided to be insertable into the main body 332 and an upper end is supported by the fork body 326, and the spring 334 configured to elastically support the main body 332 and the piston rod 333 relative to each other.

By being provided to have a hydraulic cylinder structure, the main body 332 and the piston rod 333 may, according to a liquid pressure, absorb and attenuate impact and loads applied to the wheel 10. Also, the lower end of the main body 332 is inserted into and supported by the accommodator formed to be recessed in the bracket 312 of the knuckle 310, and the upper end of the piston rod 333 is supported by the fork body 326, and thus the main body 332 and the piston rod 333 may, by operating to expand and contract in the up-down direction, absorb and attenuate vibration and impact applied from a road surface to the wheel 10. Also, by rotating along with the fork body 326 and the knuckle 310 during the operation of the steering device 320, the main body 332 and the piston rod 333 can stably absorb the impact and vibration applied from a road surface to the wheel 10 regardless of a steering angle of the wheel 10.

The spring 334 may elastically support the main body 332 and the piston rod 333 relative to each other. The spring 334 may be provided in the form of a coil and may be disposed on an outer side of the piston rod 333. One end of the spring 334 may be adhered to and supported by the first support 335 installed to be fixed to the main body 332, and the other end of the spring 334 may be adhered to and supported by a second support 336 installed to be fixed to the fork body 326 or the piston rod 333. Portions of the first and second supports 335 and 336 that come in contact with the spring 334 are formed to be bent, and in this way, the first and second supports 335 and 336 may prevent the spring 334 from falling and stably mount and support the spring 334.

The first and second reinforcing structures 350 and 360 are provided to, while promoting structural stability despite loads in various directions that are applied to the wheel 10, suppress an increase in the size of an installation space and improve the space utilization of the vehicle. The first reinforcing structure 350 may be provided between the fork 325 and the vehicle body S, and the second reinforcing structure 360 may be provided between the knuckle 310 and the fork 325.

The first reinforcing structure 350 may include a reinforcing rail 351 supported by the vehicle body S and formed to extend along a rotation path of the fork 325 and a reinforcing member interposed between the fork 325 and the reinforcing rail 351 and provided to be movable along the reinforcing rail 351 along with the fork 325.

The reinforcing rail 351 may be formed to extend along the rotation path of the fork 325 or may be formed in an arc shape about a steering axis of the wheel 10 and installed to be fixed to the vehicle body S. The reinforcing rail 351 may be fixed to the vehicle body S through at least one support arm 355, and to this end, one end of the support arm 355 may be connected and fixed to the reinforcing rail 351, and the other end of the support arm 355 may be connected and fixed to the vehicle body S. The reinforcing rail 351 may be provided with a material having sufficient stiffness, such as steel, to increase stiffness of components such as the steering device 320, the suspension device 330, and the wheel 10 and stably bear a load transmitted from the wheel 10.

The reinforcing member may be provided at the fork 325 and may be provided to be movable along the reinforcing rail 351 while in contact with and supported by the reinforcing rail 351. The reinforcing member may be provided as a cylindrical reinforcing ring 352 having a support hole 353 formed therein to allow the reinforcing rail 351 to pass therethrough, and the reinforcing ring 352 may be rotatably connected and coupled to the inner side end (the right side end based on FIG. 11) of the fork body 326. A hinge axis 352a of the reinforcing ring 352 relative to the fork body 326 may be disposed parallel to the front-rear direction of the wheel 10. In this way, even in a case in which a slight displacement of the fork body 326 occurs in the up-down direction due to the operation of the suspension device 330, the connection and contact between the fork body 326 and the reinforcing rail 351 via the reinforcing ring 352 can be stably maintained through relative displacement or rotation between the fork body 326 and the reinforcing ring 352.

The support hole 353 formed in the reinforcing ring 352 may be provided in a direction parallel to an extending direction of the reinforcing rail 351, and a slit 354 through which the support arm 355, configured to support the reinforcing rail 351 at the vehicle body S, passes may be formed to be open in one side of the support hole 353. Although FIGS. 10 to 13 illustrate the support arm 355 as being installed at a side portion of the reinforcing rail 351 and the slit 354 as being formed in a side portion of the reinforcing ring 352, the positions at which the support arm 355 and the slit 354 are formed may be changed in various ways according to the type of vehicle or the form of the vehicle body S.

In this way, as the reinforcing rail 351 is formed to extend in the shape of a curved line about the rotation path or steering axis of the fork 325, and the fork 325 rotates while supported by the reinforcing rail 351 via the reinforcing ring 352, steering of the wheel 10 can be stably performed, and simultaneously, loads applied to the fork 325 can be absorbed and distributed by the first reinforcing structure 350 so that the structural stability of the wheel module 300 is improved. Further, since the reinforcing ring 352 rotates along with the fork 325 while rotatably connected to the fork 325, the loads transmitted to the fork 325 can be borne regardless of a steering angle of the wheel 10, and thus the operational reliability of the wheel module 300 can be promoted.

The second reinforcing structure 360 may be interposed between the bracket 312 of the knuckle 310 and the fork link 327 to connect the knuckle 310 and the fork 325 and may allow the relative displacement between the knuckle 310 and the fork 325. Specifically, the second reinforcing structure 360 may have one end rotatably connected to the bracket 312 of the knuckle 310 and the other end rotatably connected to a lower end of the fork link 327, and rotation axes at both ends of the second reinforcing structure 360 may be disposed parallel to the front-rear direction of the wheel 10 as described above.

The second reinforcing structure 360 may be provided as a pair of second reinforcing structures 360, and the pair of second reinforcing structures 360 may be connected to side portions of the bracket 312 and the fork link 327. That is, by the pair of second reinforcing structures 360 having one end rotatably connected to a side surface of the bracket 312 and the other end rotatably connected to a side surface of the fork link 327, a structure may be formed in which the knuckle 310 and the damper 331 pass through a space formed between the pair of second reinforcing structures 360 when the relative displacement between the knuckle 310 and the fork 325 occurs due to compression of the damper 331.

In this way, while firmly connecting the knuckle 310 and the fork 325 so that the knuckle 310 and the fork 325 rotate integrally by rotation power provided from the steering device 320 and thus stable steering of the wheel 10 is implemented, the second reinforcing structure 360 may transmit and distribute a load applied from a road surface to the wheel 10 to the fork 325 to prevent the load from being concentrated. Further, by the second reinforcing structure 360 being rotatably connected to each of the knuckle 310 and the fork 325 and thus allowing the relative displacement in the vertical direction or up-down direction between the knuckle 310 and the fork 325 and transmitting vibration and impact applied from a road surface to the wheel 10 to the damper 331, the riding comfort of the vehicle can be improved.

Hereinafter, the wheel module 400 according to a fourth embodiment of the present disclosure will be described.

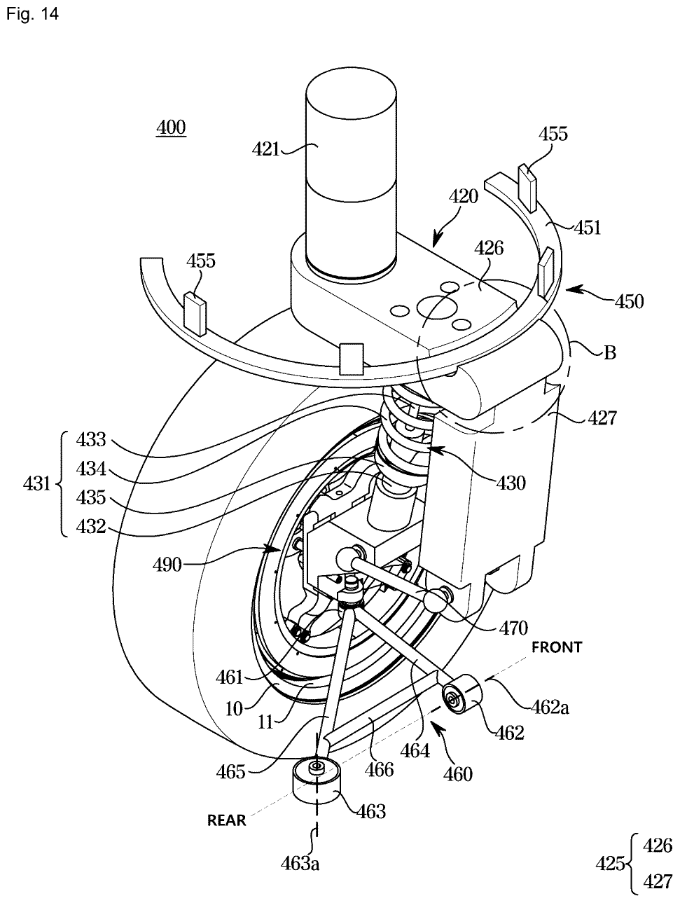

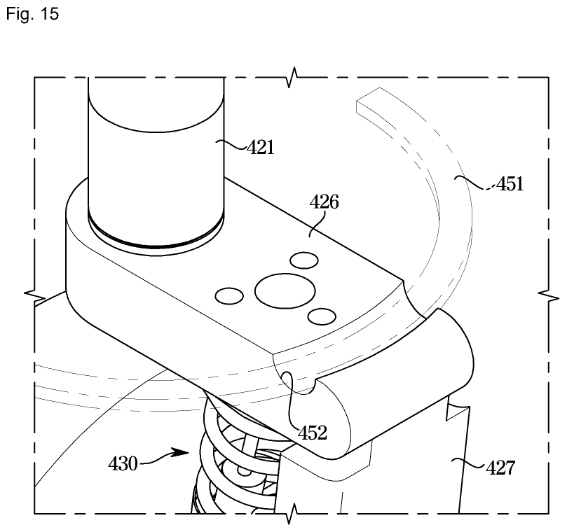

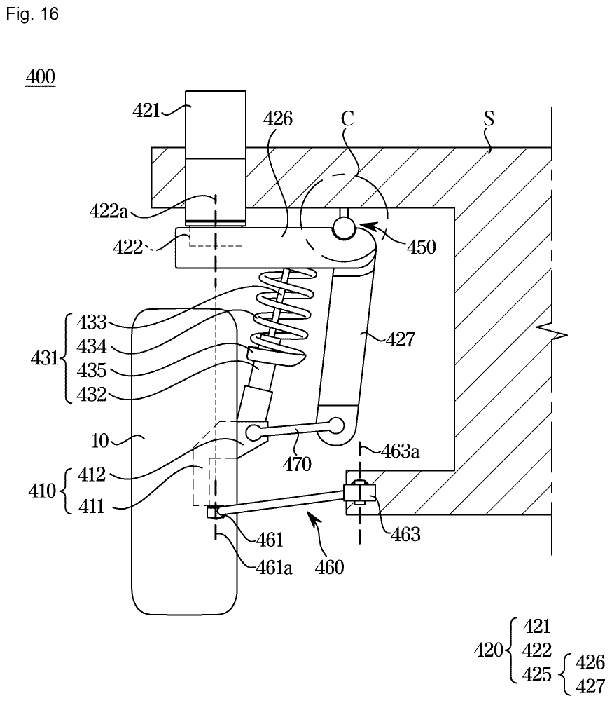

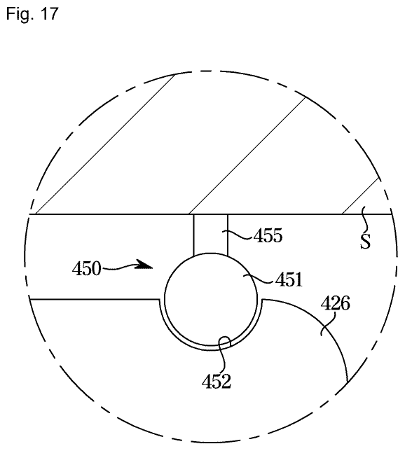

FIGS. 14 to 19 are views illustrating the wheel module 400 according to the fourth embodiment of the present disclosure. Specifically, FIG. 14 is a perspective view illustrating the wheel module 400 according to the fourth embodiment of the present disclosure, and FIG. 15 is an enlarged view of portion B of FIG. 14. Also, FIG. 16 is a lateral view illustrating the wheel module 400 according to the fourth embodiment of the present disclosure, and FIG. 17 is an enlarged view of portion C of FIG. 16.

In the following description of the wheel module 400 according to the fourth embodiment of the present disclosure, except for a case in which an additional description is given using reference numerals different from above, the description is the same as the above-given descriptions of the wheel modules 100 and 300 according to the first and third embodiments, and such descriptions will be omitted to avoid redundancy of the content.

Referring to FIGS. 14 to 17, the wheel module 400 according to the fourth embodiment of the present disclosure is provided to include a driving device installed on an inner side of the wheel 10 of a vehicle and configured to provide a rotational force of the wheel 10, a braking device configured to control a rotational speed of the wheel 10 and brake the vehicle, a steering device 420 configured to steer the wheel 10, a suspension device 430 configured to absorb and reduce vibration, noise, and the like transmitted from a road surface to the wheel 10, a knuckle 410 configured to rotatably support the wheel 10, a first reinforcing structure 450 provided between a fork 425 and the vehicle body S to increase the stiffness of the wheel module 400, a second reinforcing structure 460 provided between the knuckle 410 and the vehicle body S to increase the stiffness of the wheel module 400, and a third reinforcing structure 470 provided between the knuckle 410 and the fork 425 to increase the stiffness of the wheel module 400.

The vehicle body S which will be described below is a part of a vehicle and may be understood as a concept encompassing various fixtures or fixed portions that can stably support components such as a chassis.

The wheel 10 may be provided as a plurality of wheels 10 installed on a vehicle, and the wheel module 400 according to the fourth embodiment of the present disclosure may be provided on each of the plurality of wheels 10. The wheel 10 may rotate while in contact with a road surface and thus cause the vehicle to move, and the wheel 10 may include a rim 11 having an outer peripheral portion along which a tire is installed and at least one spoke 12 connected to the rim 11 to rotate along with the rim 11 and form an exterior of the wheel 10. The driving device configured to provide a rotational force to the wheel 10 and cause the vehicle to travel and the braking device configured to control the rotational speed of the wheel 10 and brake the vehicle may be disposed on a mounting portion 15 at an inner side that is formed by the rim 11 and the spoke 12.

A driving device 490 may be provided on an inner side of the mounting portion 15 of the wheel 10 and may receive power from a power supply such as a battery and generate rotation power for rotation of the wheel 10. The driving device may include a driving motor (not illustrated) configured to generate the rotation power by electrical energy, and the driving motor may include a rotor installed to be fixed to the spoke 12, a rotator installed to be fixed to the rotor and having a magnetic force, and a stator provided to face the rotator and having a magnetic force. However, this is only an example to help understanding the present disclosure, and the present disclosure is not limited thereto. As long as the driving device is disposed on the inner side of the wheel 10 and may receive power and cause the wheel 10 to rotate and the vehicle to move, the driving device may be understood to be the same as above even in a case in which the driving device is provided as a device of various other methods and structures.

The braking device (not illustrated) may be provided on the inner side of the mounting portion 15 of the wheel 10 like the driving device and may suppress the rotation of the wheel 10 and perform braking of the vehicle. The braking device may be provided as a device of various methods that is configured to receive power from a power supply such as a battery and control the rotational speed of the wheel 10. As an example, the braking device may, by a structure made of a nut and a spindle and configured to convert a rotational force of a braking motor configured to generate power into linear motion, approach and move away from the rim 11 to control the rotational speed of the wheel 10. In addition, the braking device may use a piston, configured to move back and forth by the power of the braking motor, to generate a liquid pressure in a pressurizing medium and transmit the liquid pressure to a cylinder provided at the wheel 10 to control the rotational speed of the wheel 10. However, the present disclosure is not limited thereto, and of course, as long as the braking device is disposed on the inner side of the wheel 10 and may receive power and control the rotational speed of the wheel 10 to perform braking of the vehicle, the braking device according to the present embodiment may be provided as a device of various other methods and structures.

At least any one of the driving device and the braking device may be rotatably supported by and connected to the knuckle 410 and thus be supported by the vehicle body S, and the knuckle 410 may rotatably support the wheel 10 via the driving device or the braking device. Also, by being provided to connect the wheel 10 to the steering device 420 and the suspension device 430 which will be described below, the knuckle 410 may transmit an operation of the steering device 420 to the wheel 10 to perform steering of the wheel 10 or may transmit vibration and noise applied from a road surface to the wheel 10 to the suspension device 430 to induce attenuation of the vibration and noise.

The knuckle 410 may include a hub 411 connected to at least any one of the driving device and the braking device and a bracket 412 formed to extend from an inner side end (a right side end based on FIG. 16) of the hub 411 and connected to the steering device 420 and the suspension device 430 which will be described below.

An outer side end (a left side end based on FIG. 16) of the hub 411 may rotatably support the wheel 10 via the driving device or the braking device, and in order to promote weight reduction and simplify the structure, the hub 411 may be provided in the shape of a ring and may be disposed to be coaxial with a rotation axis of the wheel 10. A first end 461 of the second reinforcing structure 460 which will be described below may be rotatably connected to a lower end of the hub 411, and this will be described in detail below.

The bracket 412 may be formed to extend or expand toward one side from the inner side end of the hub 411. An accommodator in which a main body 432 of a damper 431 which will be described below is inserted and installed may be formed to be recessed in an upper side of the bracket 412, and one end of the third reinforcing structure 470 which will be described below may be rotatably connected to the upper side of the bracket 412. A rotation axis of the third reinforcing structure 470 relative to the bracket 412 may be disposed parallel to the front-rear direction of the wheel 10. Since vibration and impact applied to the wheel 10 from a speed bump on a road or from a damaged road surface are mostly generated and transmitted in the up-down direction, the rotation axis of the third reinforcing structure 470 relative to the bracket 412 may be disposed in the front-rear direction orthogonal to the up-down direction of the wheel 10 so that the vibration and impact in the up-down direction can be stably absorbed and attenuated by the suspension device 430. Also, as the one end of the third reinforcing structure 470 which will be described below is connected to the bracket 412, the third reinforcing structure 470 may be rotated or displaced along with the knuckle 410, and in this way, the suspension device 430 can stably intervene and operate regardless of a steering angle of the wheel 10. Further, by the third reinforcing structure 470 transmitting and distributing impact and vibration applied from a road surface to the wheel 10 toward a fork link 427 which will be described below, a load can be prevented from being concentrated to one portion.

The steering device 420 is provided to rotate the knuckle 410 and the wheel 10 connected thereto to steer the wheel 10.

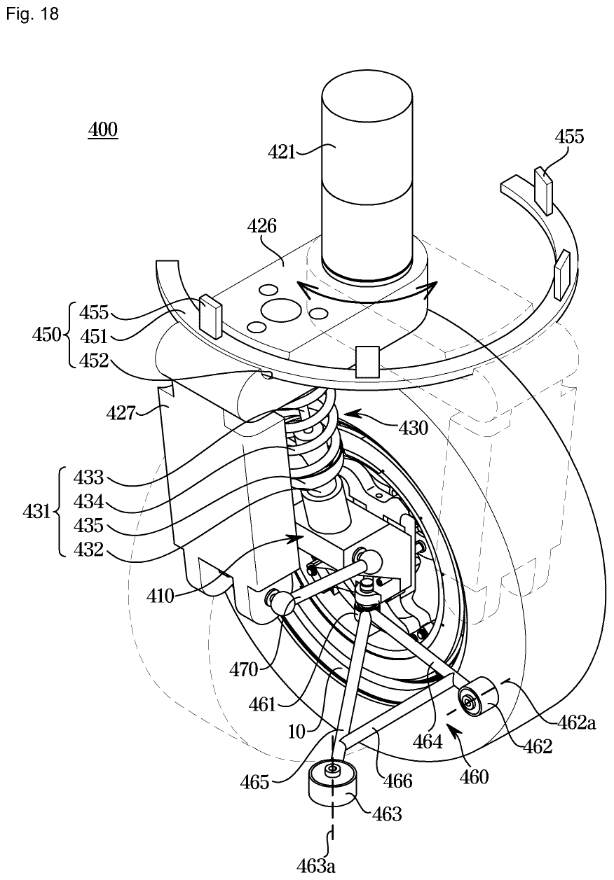

FIG. 18 is a perspective view illustrating an operational state in which the wheel 10 is steered by the steering device 420. Referring to FIGS. 14 to 18, the steering device 420 may include an actuator 421 configured to provide rotation power for steering of the wheel 10 and the fork 425 connected to an output shaft 422 of the actuator 421 and configured to rotate, and the fork 425 and the knuckle 410 may be connected by the suspension device 430 and the third reinforcing structure 470 which will be described below and thus may rotate integrally.

The actuator 421 may be installed to be fixed to the vehicle body S, and the output shaft 422 may be connected to a fork body 426 which will be described below. The actuator 421 may receive power from a power supply such as a battery and generate rotation power for steering of the wheel 10. The actuator 421 may include a steering motor configured to generate the rotation power by electrical energy, and the output shaft 422 may be connected and fixed to operate integrally with the fork 425 and thus may transmit and output the rotation power of the steering motor to the fork 425 and cause steering of the wheel 10 to occur.

The actuator 421 may be installed and disposed above the fork body 426 which will be described below, and the output shaft 422 of the actuator 421 may be connected and fixed to the fork body 426 which will be described below and may be disposed in a direction parallel to the vertical direction. The output shaft 422 of the actuator 421 may have a rotation axis 422a provided to be coaxial with a first axis 461a of the second reinforcing structure 460 which will be described below, and this will be described in detail below.

The fork 425 may be connected and fixed to the output shaft 422 of the actuator 421 and rotate. The fork 425 may include the fork body 426 formed to extend in the horizontal direction above the wheel 10 and connected and fixed to the output shaft 422 of the actuator 421 and the fork link 427 rotatably connected to and formed to extend downward from an inner side end (a right side end based on FIG. 16) of the fork body 426. By the fork body 426 being disposed above the wheel 10 and the fork link 427 being disposed beside the wheel 10, the actuator 421, the suspension device 430, or the like may function and operate while adjacent to the wheel 10.

The fork body 426 may be disposed above the wheel 10, and the actuator 421 may be installed at the fork body 426. Specifically, by the output shaft 422 of the actuator 421 being inserted into or fixed to the fork body 426, the fork body 426 may rotate integrally with the output shaft 422 of the actuator 421. In this way, the operation of the actuator 421 may cause the fork 425, the suspension device 430, the third reinforcing structure 470, and the knuckle 410 to rotate, and thus, an operation of steering the wheel 10 may be performed. The damper 431 of the suspension device 430 which will be described below may be connected to and supported by a lower surface of the fork body 426, and a first support 435 configured to support the other end of a spring 434 of the damper 431 which will be described below may be installed to be fixed to the lower surface of the fork body 426.

The fork link 427 may be rotatably connected to the inner side end (the right side end based on FIG. 16) of the fork body 426 and may be formed to extend downward therefrom to face the rotation axis of the wheel 10 or a rear surface (a right side surface based on FIG. 16) of the wheel 10. The fork body 426 and the fork link 427 may rotate integrally by the operation of the actuator 421 and may be rotatably connected to each other with a direction parallel to the front-rear direction of the wheel 10 as a rotation axis. In this way, during attenuation of impact and vibration by the suspension device 430 which will be described below, loads applied to the fork 425 can be stably absorbed and borne, and since a flexible operation of the fork 425 becomes possible, performance of attenuating impact and vibration by the suspension device 430 can be improved.

A support groove 452 provided to be movable along a reinforcing rail 451 of the first reinforcing structure 450 which will be described below may be formed to be recessed in the fork body 426, and the other end of the third reinforcing structure 470 which will be described below may be rotatably connected to a lower side of the fork link 427. A rotation axis of the third reinforcing structure 470 relative to the fork link 427 may be disposed parallel to the front-rear direction of the wheel 10, and thus the suspension device 430 can stably absorb and attenuate vibration and impact in the up-down direction that are applied to the wheel 10 from a speed bump on a road or from a damaged road surface. Also, as the suspension device 430 is rotated or displaced along with the knuckle 410 and the fork 425, the suspension device 430 can stably intervene and operate regardless of a steering angle of the wheel 10. Further, by the impact and vibration applied from a road surface to the wheel 10 being transmitted and distributed toward the fork link 427 by the third reinforcing structure 470, a load can be prevented from being concentrated to one portion.

The suspension device 430 is provided between the steering device 420 and the knuckle 410 and provided to attenuate various vibrations and noises applied from a road surface to the wheel 10. To this end, the suspension device 430 may be provided to include the damper 431 provided between the fork body 426 and the bracket 412.

One end of the damper 431 may be supported by the fork body 426, and the other end of the damper 431 may be supported by the bracket 412 of the knuckle 410. Specifically, the damper 431 may include the main body 432 of which a lower end is supported by the bracket 412, a piston rod 433 of which at least one portion is provided to be insertable into the main body 432 and an upper end is supported by the fork body 426, and the spring 434 configured to elastically support the main body 432 and the piston rod 433 relative to each other.

By being provided to have a hydraulic cylinder structure, the main body 432 and the piston rod 433 may, according to a liquid pressure, absorb and attenuate impact and loads applied to the wheel 10. Also, the lower end of the main body 432 is inserted into and supported by the accommodator formed to be recessed in the bracket 412 of the knuckle 410, and the upper end of the piston rod 433 is supported by the fork body 426, and thus the main body 432 and the piston rod 433 may, by operating to expand and contract in the up-down direction, absorb and attenuate vibration and impact applied from a road surface to the wheel 10. Also, by rotating along with the fork body 426 and the knuckle 410 during the operation of the steering device 420, the main body 432 and the piston rod 433 can stably absorb the impact and vibration applied from a road surface to the wheel 10 regardless of a steering angle of the wheel 10.

The spring 434 may elastically support the main body 432 and the piston rod 433 relative to each other. The spring 434 may be provided in the form of a coil and may be disposed on an outer side of the piston rod 433. One end of the spring 434 may be adhered to and supported by the first support 435 installed to be fixed to the main body 432, and the other end of the spring 434 may be adhered to and supported by a second support 436 installed to be fixed to the fork body 426 or the piston rod 433. Portions of the first and second supports 435 and 436 that come in contact with the spring 434 are formed to be bent, and in this way, the first and second supports 435 and 436 may prevent the spring 434 from falling and stably mount and support the spring 434.

The first to third reinforcing structures 450, 460, and 470 are provided to, while promoting structural stability despite loads in various directions that are applied to the wheel 10, suppress an increase in the size of an installation space and improve the space utilization of the vehicle. The first reinforcing structure 450 may be provided between the fork 425 and the vehicle body S, the second reinforcing structure 460 may be provided between the knuckle 410 and the vehicle body S, and the third reinforcing structure 470 may be provided between the knuckle 410 and the fork 425.

The first reinforcing structure 450 may include the reinforcing rail 451 supported by the vehicle body S and formed to extend along a rotation path of the fork 425 and the support groove 452 formed to be recessed in the fork 425 and provided to be movable along the reinforcing rail 451 along with the fork 425 while at least one portion of the reinforcing rail 451 is inserted into and supported by the support groove 452.

The reinforcing rail 451 may be formed to extend along the rotation path of the fork 425 or may be formed in an arc shape about a steering axis of the wheel 10 and installed to be fixed to the vehicle body S. The reinforcing rail 451 may be fixed to the vehicle body S through at least one support arm 455, and to this end, one end of the support arm 455 may be connected and fixed to the reinforcing rail 451, and the other end of the support arm 455 may be connected and fixed to the vehicle body S. The reinforcing rail 451 may be provided with a material having sufficient stiffness to increase stiffness of components such as the steering device 420, the suspension device 430, and the wheel 10 and stably bear a load transmitted from the wheel 10.

The support groove 452 may be formed to be recessed in the fork 425 and provided to be movable along the reinforcing rail 451 while at least one portion of the reinforcing rail 451 is inserted into and supported by the support groove 452. The support groove 452 may be formed to be recessed in the fork body 426 while having a shape corresponding to a cross-sectional shape of the reinforcing rail 451 and may be provided in a direction parallel to an extending direction of the reinforcing rail 451. Meanwhile, although not illustrated in the drawings, in a case in which the support groove 452 is, when being formed to be recessed in the fork body 426, provided to surround the entire circumference of the reinforcing rail 451 so that the sizes of a surface in contact with the reinforcing rail 451 and a surface supporting the reinforcing rail 451 are increased, a slit (not illustrated) through which the support arm 455, configured to support the reinforcing rail 451 at the vehicle body S, passes may be formed to be open in one side of the support groove 452.

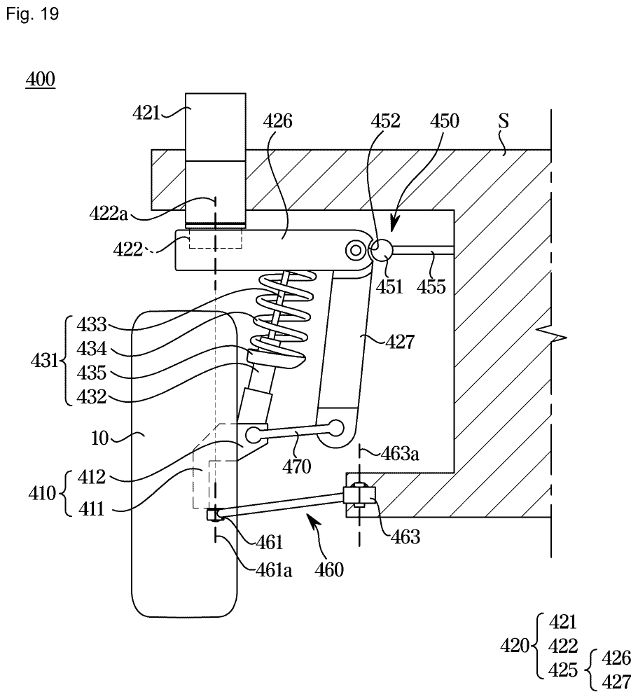

Although FIGS. 15 to 17 illustrate the reinforcing rail 451 as being provided at a portion above the fork body 426 in the vehicle body S and the support groove 452 as being formed to be recessed in an upper surface of the fork body 426 to face the reinforcing rail 451, as long as loads applied to the fork 425 may be absorbed and distributed, the reinforcing rail 451 and the support groove 452 may be formed at various other positions. As an example, FIG. 19 is a lateral view illustrating a modified embodiment of the wheel module 400 according to the fourth embodiment of the present disclosure, and referring to FIG. 19, the reinforcing rail 451 may be provided at a portion inside the fork body 426 in the vehicle body S, and the support groove 452 may be formed to be recessed in an inner side end of the fork body 426 to face the reinforcing rail 451 in order to absorb and distribute the loads applied to the fork 425.

In this way, as the reinforcing rail 451 is formed to extend in the shape of a curved line about the rotation path or steering axis of the fork 425, and the fork 425 rotates while in contact with and supported by the reinforcing rail 451 via the support groove 452, steering of the wheel 10 can be stably performed, and simultaneously, loads applied to the fork 425 can be absorbed and distributed by the first reinforcing structure 450 so that the structural stability of the wheel module 400 is improved.

The second reinforcing structure 460 is provided between the knuckle 410 and the vehicle body S and provided to, while promoting the structural stability of the wheel module 400, suppress an increase in the size of an installation space and improve the space utilization of the vehicle.

The second reinforcing structure 460 may be provided to include the first end 461 rotatably connected to the knuckle 410, second and third ends 462 and 463 rotatably connected to the vehicle body S, a first frame 464 configured to connect the first end 461 and the second end 462 to each other, a second frame 465 configured to connect the first end 461 and the third end 463 to each other, and a support frame 466 provided between the first frame 464 and the second frame 465 and configured to reinforce stiffness.

The first end 461 is rotatably connected to the knuckle 410 along the first axis 461a disposed parallel to the vertical direction or up-down direction. The first end 461 may be connected to the lower end of the hub 411 of the knuckle 410 to suppress an increase in the size of the wheel module 400, and the first axis 461a may be provided to be coaxial with the rotation axis 422a of the output shaft 422 of the steering device 420. As illustrated in FIG. 16, as the rotation axis 422a of the output shaft 422 of the actuator 421 and the first axis 461a of the first end 461 are provided to be coincident and coaxial with each other, the rotation axis 422a of the output shaft 422 and the first axis 461a of the first end 461 may together constitute a kingpin of the steering device 420. In this way, steering of the wheel 10 is stably performed during the operation of the steering device 420, and simultaneously, some of the load applied to the fork 425 and the knuckle 410 during steering is absorbed and distributed by the first end 461 of the second reinforcing structure 460. As a result, the structural stability of the wheel module 400 can be improved.

The second end 462 may be rotatably connected to the vehicle body S along a second axis 462a disposed parallel to the longitudinal direction of the vehicle body S. The second end 462 may be connected to the first end 461 by the first frame 464, and to this end, the first end 461 may be disposed at one end of the first frame 464, and the second end 462 may be disposed at the other end of the first frame 464. By being rotatably connected to and supported by the vehicle body S along the second axis 462a parallel to the longitudinal direction of the vehicle body S, the second end 462 can bear a load in a transverse direction orthogonal to the second axis 462a, in other words, a load applied in the width direction of the vehicle body S to the wheel 10 or the wheel module 400. The first frame 464 may be formed to extend in a direction parallel to the width direction of the vehicle body S or a direction corresponding to the width direction to more stably bear the load in the transverse direction that is applied to the wheel 10 or the wheel module 400.

The third end 463 may be rotatably connected to the vehicle body S along a third axis 463a disposed parallel to the vertical direction or up-down direction. The third end 463 may be connected to the first end 461 by the second frame 465, and to this end, the first end 461 may be disposed at one end of the second frame 465, and the third end 463 may be disposed at the other end of the second frame 465. By being rotatably connected to and supported by the vehicle body S along the third axis 463a parallel to the vertical direction or up-down direction of the vehicle body S, the third end 463 can bear a load in a longitudinal direction orthogonal to the third axis 463a, in other words, a load applied in the longitudinal direction of the vehicle body S to the wheel 10 or the wheel module 400.

Meanwhile, generally, the number of times and amount of time a vehicle is driven forward are relatively larger than the number of times and amount of time the vehicle is driven rearward, and during forward driving, the speed of the vehicle is high, and thus a load applied to the wheel 10 or the wheel module 400 is greater. That is, during forward driving of the vehicle, the longitudinal load applied to the wheel 10 or the wheel module 400 is mostly applied to the rear of the vehicle body S. Accordingly, the third end 463 may be disposed behind the second end 462 in the vehicle body S. Further, the second frame 465 may be formed to extend to be inclined toward the rear of the vehicle body S to more stably bear the longitudinal load toward the rear that is applied to the wheel 10 or the wheel module 400. As a result, the second frame 465 may be disposed at a certain angle with respect to the first frame 464.

In this way, since the second end 462 and the third end 463 of the second reinforcing structure 460 are each rotatably connected to the vehicle body S, and the rotation axis (second axis) of the second end 462 and the rotation axis (third axis) of the third end 463 are disposed orthogonal to each other, loads in various directions that are applied to the wheel 10 or the wheel module 400 can be stably absorbed and distributed, and thus the structural stability of the wheel module 400 and operational reliability of various devices can be improved.

As illustrated in FIGS. 13 and 15, the second end 462 and the third end 463 of the second reinforcing structure 460 may be disposed and connected at the same height on the vehicle body S to, in a case in which a load is applied to the wheel 10 or the wheel module 400, prevent the load from being concentrated to one portion. Alternatively, the second end 462 and the third end 463 of the second reinforcing structure 460 may be disposed on the same phase based on the longitudinal direction of the vehicle body S to prevent the load from being concentrated to one portion and evenly transmit and distribute the load toward the vehicle body S. In this way, despite loads applied in various directions during traveling of the vehicle or steering of the wheel 10, a load can be prevented from being concentrated to one point of the second reinforcing structure 460 to promote the structural stability of the second reinforcing structure 460 and the wheel module 400, and a load applied to the vehicle body S via the second and third ends 462 and 463 of the second reinforcing structure 460 can also be prevented from being concentrated to improve the structural stability of the vehicle body S and the durability of the vehicle.

The second reinforcing structure 460 may have the support frame 466 provided between the first frame 464 and the second frame 465 to further reinforce the stiffness. The support frame 466 may have one end connected to the first frame 464 and the other end connected to the second frame 465, and an extending direction of the support frame 466 may be different from extending directions of the first and second frames 464 and 465 to easily distribute loads applied in various directions. As an example, in a case in which the first frame 464 extends in a direction corresponding to the width direction of the vehicle body S and the second frame 465 is formed to extend to be inclined toward the rear of the vehicle body S, the support frame 466 may be formed to extend in the longitudinal direction of the vehicle body S so that the first and second frames 464 and 465 and the support frame 466 are disposed in directions different from each other, and in this way, loads in various directions that are applied to the wheel 10 or the wheel module 400 can be stably borne, and the loads can be transmitted and distributed to surrounding members.

The third reinforcing structure 470 may be interposed between the bracket 412 of the knuckle 410 and the fork link 427 to connect the knuckle 410 and the fork 425 and may allow the relative displacement between the knuckle 410 and the fork 425. Specifically, the third reinforcing structure 470 may have one end rotatably connected to the bracket 412 of the knuckle 410 and the other end rotatably connected to a lower end of the fork link 427, and rotation axes at both ends of the third reinforcing structure 470 may be disposed parallel to the front-rear direction of the wheel 10 as described above.

The third reinforcing structure 470 may be provided as a pair of third reinforcing structures 470, and the pair of third reinforcing structures 470 may be connected to side portions of the bracket 412 and the fork link 427. That is, by the pair of third reinforcing structures 470 having one end rotatably connected to a side surface of the bracket 412 and the other end rotatably connected to a side surface of the fork link 427, a structure may be formed in which the knuckle 410 and the damper 431 pass through a space formed between the pair of third reinforcing structures 470 when the relative displacement between the knuckle 410 and the fork 425 occurs due to compression of the damper 431.

In this way, while firmly connecting the knuckle 410 and the fork 425 so that the knuckle 410 and the fork 425 rotate integrally by rotation power provided from the steering device 420 and thus stable steering of the wheel 10 is implemented, the third reinforcing structure 470 may transmit and distribute a load applied from a road surface to the wheel 10 to the fork 425 to prevent the load from being concentrated. Further, by the third reinforcing structure 470 being rotatably connected to each of the knuckle 410 and the fork 425 and thus allowing the relative displacement in the vertical direction or up-down direction between the knuckle 410 and the fork 425 and transmitting vibration and impact applied from a road surface to the wheel 10 to the damper 431, the riding comfort of the vehicle can be improved.

A wheel module according to the present embodiments can improve durability and operational stability of components despite loads in various directions that are transferred to each wheel during traveling of a vehicle.

A wheel module according to the present embodiments can secure a wide indoor space of a vehicle and improve the space utilization of the vehicle by reducing the size or scale of a device.

A wheel module according to the present embodiments can improve maneuverability of a vehicle by implementing a large steering angle even in a small installation space.

A wheel module according to the present embodiments has a simple structure and is easy to manufacture and install.

A wheel module according to the present embodiments can improve operational reliability of a device and a vehicle by improving the structural stability of the device.

A wheel module according to the present embodiments can stably and separately drive, brake, steer, and suspend each wheel.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A wheel module comprising:
a knuckle configured to rotatably support a wheel;
a steering device including an actuator configured to rotate the knuckle and steer the wheel; and
a reinforcing structure provided between the knuckle and a vehicle body,
wherein an output shaft of the actuator is disposed parallel to a vertical direction,
the reinforcing structure includes a first end rotatably connected to the knuckle along a first axis parallel to the vertical direction and a second end connected to the vehicle body, and
an output shaft rotation axis and the first axis are coaxially provided,
wherein the steering device includes a fork connected to the output shaft and configured to rotate,
wherein the fork includes:
a first fork formed to extend in a horizontal direction above the wheel and connected to the output shaft of the actuator; and
a second fork, separately from the first fork, formed to extend downward from an inner side end of the first fork.

2. The wheel module of claim 1, wherein the second end is rotatably connected to the vehicle body along a second axis parallel to a longitudinal direction of the vehicle body.

3. The wheel module of claim 2, wherein:
the reinforcing structure further includes a third end connected to the vehicle body; and
the third end is rotatably connected to the vehicle body along a third axis parallel to the vertical direction.

4. The wheel module of claim 3, wherein the third end is disposed relatively behind the second end on the vehicle body.

5. The wheel module of claim 3, wherein the reinforcing structure further includes:
a first frame having one end at which the first end is disposed and the other end at which the second end is disposed; and
a second frame having one end at which the first end is disposed and the other end at which the third end is disposed.

6. The wheel module of claim 5, wherein:
the first frame is formed to extend in a width direction of the vehicle body; and
the second frame is formed to extend toward a rear of the vehicle body and formed to be inclined with respect to the first frame.

7. The wheel module of claim 5, wherein the reinforcing structure further includes a support frame having one end connected to the first frame and the other end connected to the second frame.

8. The wheel module of claim 3, further comprising a suspension device provided between the steering device and the knuckle.

11. The wheel module of claim 1, further comprising:
a driving device installed on an inner side of the wheel and configured to provide a rotational force of the wheel; and
a braking device configured to control a rotational speed of the wheel.

12. The wheel module of claim 11, wherein knuckle includes:
a hub connected to at least any one of the driving device and the braking device; and
a bracket formed to extend or expand from an inner side end of the hub.

13. The wheel module of claim 12, wherein the suspension device includes:
an upper arm having one end rotatably connected to an upper side of the bracket and the other end rotatably connected to an upper side of the second fork; and
a lower arm having one end rotatably connected to a lower side of the bracket and the other end rotatably connected to a lower side of the second fork.

14. The wheel module of claim 13, wherein the suspension device further includes a damper having one end supported by the first fork and the other end supported by the lower arm.

15. The wheel module of claim 14, wherein the damper includes:
a main body of which a lower end is rotatably connected to and supported by the lower arm;
a piston rod of which at least one portion is provided to be insertable into the main body and an upper end is rotatably connected to and supported by the first fork; and
a spring disposed on an outer side of the piston rod and configured to elastically support the main body and the piston rod relative to each other.

16. The wheel module of claim 12, wherein the first end is connected to a lower end of the hub.

17. The wheel module of claim 3, wherein the second end and the third end are connected at the same height on the vehicle body.

18. The wheel module of claim 3, wherein the second axis and the third axis are disposed on the same phase based on the longitudinal direction of the vehicle body.

19. The wheel module of claim 15, wherein the damper further includes:
a first support installed to be fixed to the main body and configured to support one end of the spring; and
a second support installed to be fixed to the first fork or the piston rod and configured to support the other end of the spring.

20. A wheel module comprising:
a knuckle configured to rotatably support a wheel;
a steering device configured to rotate the knuckle and steer the wheel; and
a reinforcing structure provided between the knuckle and a vehicle body,
wherein the reinforcing structure includes a first end rotatably connected to the knuckle along a first axis, a second end rotatably connected to the vehicle body along a second axis, and a third end rotatably connected to the vehicle body along a third axis,
any one of the second axis and the third axis is disposed in a direction parallel to the first axis, and
the second axis and the third axis are provided to be orthogonal to each other.
